(19) United States
(12) Patent Application Publication
(10) Pub. No.: US 2019/0213509 A1
(43) Pub. Date: Jul. 11, 2019

(54) SYSTEM FOR RELATIONAL-IMPACT BASED TASK MANAGEMENT

(71) Applicant: Walmart Apollo, LLC, Bentonville, AR (US)

(72) Inventors: Timothy James Burleson, Bentonville, AR (US); Andrew B. Millhouse, Gilbert, AZ (US); Jacob R. Schrader, Sterling, IL (US)

(21) Appl. No.: 16/231,406

(22) Filed: Dec. 22, 2018

Related U.S. Application Data
(60) Provisional application No. 62/615,704, filed on Jan. 10, 2018.

(51) Int. Cl. G06Q 10/06; G06Q 50/26; G06N 20/00

(52) U.S. Cl. CPC G06Q 10/0633; G06Q 10/063116; G06N 20/00; G06Q 10/06393; G06Q 50/265

(57) ABSTRACT

Examples provide a system for dynamic relational-impact prediction associated with task dependencies. An impact prediction component analyzes real-time context data associated with tasks being performed within a selected area to predict potential occurrence of incidents associated with tasks in a dependency chain. The dependency chain identifies one or more child tasks and/or sibling tasks which are dependent on one or more parent tasks. An impact score indicating a degree of negative impact on one or more dependent tasks is generated for each task having one or more predicted incidents associated with the task. Corrective instructions are output to one or more users performing the task and/or the task can be reassigned to one or more different users based on the impact score. Where multiple qualified users are available to perform a task in a dependency chain, the task is assigned to the user having the highest per-task safety score.

### BACKGROUND

People engaged in performing tasks or other activities in distribution centers, stores, and other locations frequently require training and supervision in the correct way in which to perform tasks correctly, safely, and efficiently. This training frequently requires manual instruction and personal supervision by managers and other training personnel. Moreover, there can be large numbers of people being trained simultaneously. This is a potentially time-consuming, labor-intensive, and inefficient procedure.

### SUMMARY

Examples of the disclosure provide a system for relational-impact based task allocation. The system includes a memory and at least one processor communicatively coupled to the memory. An incident prediction generator analyzes real-time context data associated with a selected area and historical safety data using a set of safety criteria and pattern recognition variables to predict occurrence of at least one incident associated with at least one task being performed within the selected area. A task dependency component generates a dependency chain associated with a selected task associated with the predicted incident. The selected task is assigned to a first user in a plurality of users within the selected area. The dependency chain identifies a set of child tasks dependent upon completion of the selected task assigned to the first user. A safety impact component calculates an impact score for the set of child tasks based on an analysis of the generated incident prediction, task data associated with the set of child tasks and a set of weighted task impact variables. The selected task is re-assigned to a second user having a higher per-task safety score than the first user on condition the safety impact score indicates a dependent-task negative impact associated with at least one child task in the set of child tasks because of the predicted incident.

Other examples provide a computer-implemented method for relational-impact based task allocation. A safety impact component calculates a per-task safety score for each user in a plurality of users qualified to perform a selected task in a plurality of tasks within a task dependency chain. The per-task safety score is calculated based on analysis of historical safety data for the plurality of users and task data associated with the selected task. A task assignment component assigns the selected task to a first user in the plurality of users having a highest per-task safety score associated with the selected task. A safety impact component analyzes context data associated with the selected area, sensor data generated by a set of sensors associated with the selected area, task data associated with a set of dependent tasks in a dependency chain associated with the selected task, and a set of incident predictions associated with the set of dependent tasks using a set of weighted task impact variables to generate an impact score for the set of dependent tasks. A notification component initiates corrective measures associated with the at least one dependent task on condition the task impact score indicates a negative impact on the selected task due to at least one incident predication associated with at least one dependent task in the set of dependent tasks within the dependency chain.

Still other examples provide one or more computer storage media, having computer-executable instructions for relational-impact based task assignment that, when executed by a computer cause the computer to generate a dependency chain associated with a selected task assigned to a first user in a plurality of users within a selected area on condition a generated incident prediction indicates occurrence of a predicted incident associated with the selected task prior to task completion, the dependency chain identifying a set of dependent tasks. A dependent task includes a sibling task completed substantially concurrently with the selected task or a child task dependent upon completion of the selected. An impact score for the set of dependent tasks is calculated based on an analysis of the generated incident prediction, task data associated with the set of dependent tasks and a set of weighted impact variables. The first task is re-assigned to a second user on condition the impact score is within a safety impact score threshold range indicating a negative safety impact on at least one user assigned to at least one dependent task in the set of dependent tasks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for generating dependency task-based impact predictions and performing corrective actions in real-time.

FIG. 2 is an exemplary block diagram illustrating a system for task-based impact predictions including an impact prediction component.

FIG. 3 is an exemplary block diagram illustrating a system for task-impact based task management.

FIG. 4 is an exemplary block diagram illustrating a plurality of sources of task-based impact data.

FIG. 5 is an exemplary block diagram illustrating a machine learning component for generating a set of weighted impact variables.

FIG. 6 is an exemplary block diagram illustrating a plurality of areas associated with a plurality of users assigned to perform a plurality of tasks.

FIG. 7 is an exemplary block diagram illustrating a set of dependent tasks associated with a selected task.

FIG. 8 is an exemplary block diagram illustrating a dependency chain.

FIG. 9 is an exemplary block diagram illustrating a set of impact variables.

FIG. 10 is an exemplary block diagram illustrating a database storing task-related impact data.

FIG. 11 is an exemplary flow chart illustrating operation of the computing device to assign a user to perform a task based on per-user safety scores.

FIG. 12 is an exemplary flow chart illustrating operation of the computing device to schedule a customized per-user break time.

FIG. 13 is an exemplary flow chart illustrating operation of the computing device to perform a corrective action to prevent a predicted negative impact associated with dependent tasks.

FIG. 14 is an exemplary screenshot illustrating task-related impact data.

FIG. 15 is another exemplary screenshot illustrating task-related impact data and a notification associated with an incident.

FIG. 16 is another screenshot illustrating task-related impact data and a safety score for a user.

Corresponding reference characters indicate corresponding parts throughout the drawings.

### DETAILED DESCRIPTION

Referring to the figures, examples of the disclosure enable a system for customized prediction of events associated with tasks in a dependency chain and performance of corrective actions to prevent occurrence of the predicted events (incidents). In some examples, an impact prediction component predicts potential incidents or other events associated with performance of one or more tasks which can occur due to deviation from recommended procedures by one or more users. The predicted incident is a prediction of a negative or undesirable outcome which has not yet occurred, but could occur or is likely to occur due to real-time conditions, including actions currently being performed or not performed (failure to perform an action or failure to complete an action) by one or more users. This enables dynamic identification of undesirable events prior to their occurrence.

The impact prediction component generates a per-task impact score for each predicted incident. The impact score quantifies a degree of negative impact on one or more other dependent tasks which are being performed concurrently with a selected task and/or which are scheduled to be performed after completion of the selected task. If none of the dependent tasks are impacted by the predicted incident, the impact score can be low or outside a negative impact threshold range. If one or more of the dependent tasks are delayed or unable to be completed due to the predicted incident, the impact score can be higher or within a negative impact threshold range.

The impact score enables accurate and dependable identification of predicted incidents likely to have a negative impact and identification of predicted incidents likely to have a negligible impact. This enables efficient corrective measure to be taken with regard to users that require assistance/additional training to reduce work latency, minimize task completion delays, improve quality of task performance, improve task completion efficiency, improve user training, and increase efficiency of user training.

The per-task impact score also enables identification of minor deviations from recommended task-related safety criteria which does not negatively impact task performance and safety. This prevents unnecessary time and effort wasted addressing matters that have no impact on task performance and/or safety for improved user efficiency, improved utilization of training time, and more accurate identification of inconsequential issues.

In other examples, the impact prediction component assigns tasks to users based on per-user safety scores assigned to each user. A task in a dependency chain having a potential high impact on one or more other dependent tasks is assigned to the user having the highest safety score for that particular task. This enables assignment of tasks to the user having the greatest skill, experience, and/or ability to adhere to safety criteria with regard to performance of that particular task. The safety score enables tasks to be assigned to users and task assignment to be adjusted based on user's past performance, user's level of training successfully completed, changing weather/environmental conditions, changing operational state of resources, changes in staffing due to illness, injury, vacation, or personal days, unexpected delivery/receiving delays, urgent orders, etc.

A task dependency component, in still other examples, generates a dependency chain associated with a task assigned to a selected user having a predicted incident associated with the task. The dependency chain identifies a set of parent tasks, a set of sibling tasks, and/or a set of child tasks associated with the task assigned to a selected user. The task dependency chain is used to determine the impact of the predicted incident on other tasks in the dependency chain. This dependency chain data can be utilized to assess the magnitude of potential delays/latency in completion of dependent tasks in the chain if the predicted incident occurs. A delay in the dependency chain refers to a delay in completing one or more tasks in the dependency chain or worktime latency for users assigned to tasks in the dependency chain.

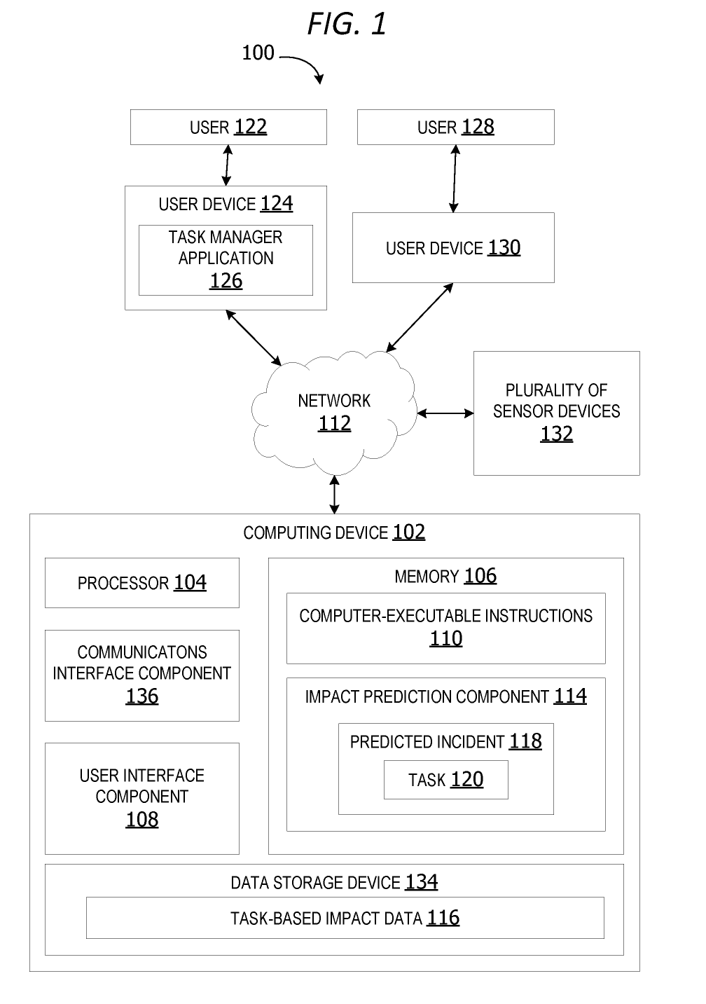

Referring again to FIG. 1, an exemplary block diagram illustrates a system 100 for generating dependency task-based impact predictions and performing corrective actions in real-time. In the example of FIG. 1, the computing device 102 represents a system 100 for scheduling user-specific break times based on task-related data and break priority rules.

The computing device 102 represents any device executing instructions (e.g., as application programs, operating system functionality, or both) to implement the operations and functionality associated with the computing device 102. The computing device 102 can include a mobile computing device, as well as less portable devices, such as desktop personal computers, kiosks, tabletop devices, industrial control devices, wireless charging stations, and electric automobile charging stations. Additionally, the computing device 102 can represent a group of processing units or other computing devices.

In some examples, the computing device 102 has at least one processor 104, a memory 106, and at least one user interface 108. The processor 104 includes any quantity of processing units and is programmed to execute computer-executable instructions 110 for predicting incidents associated with one or more tasks being performed by one or more users within a predetermined monitored area and/or performing corrective measures to prevent the incidents predicted to occur proactively before an incident occurs instead of responding reactively after an incident has already occurred.

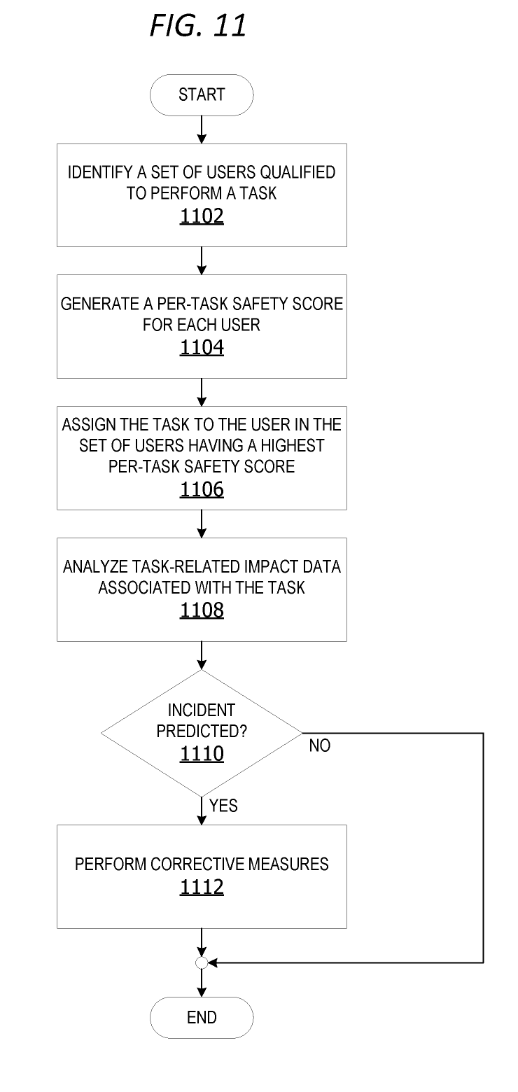

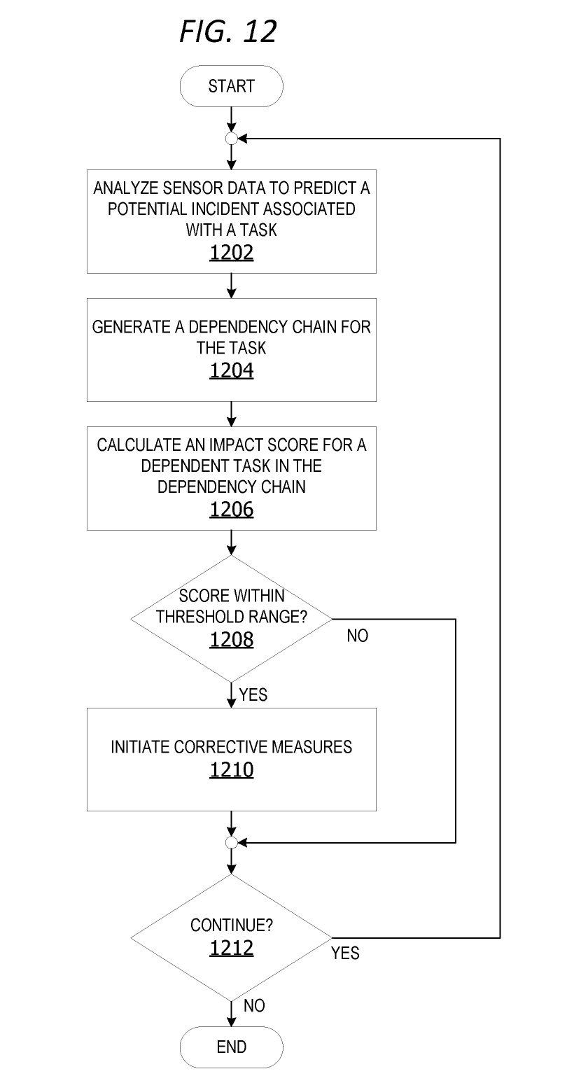

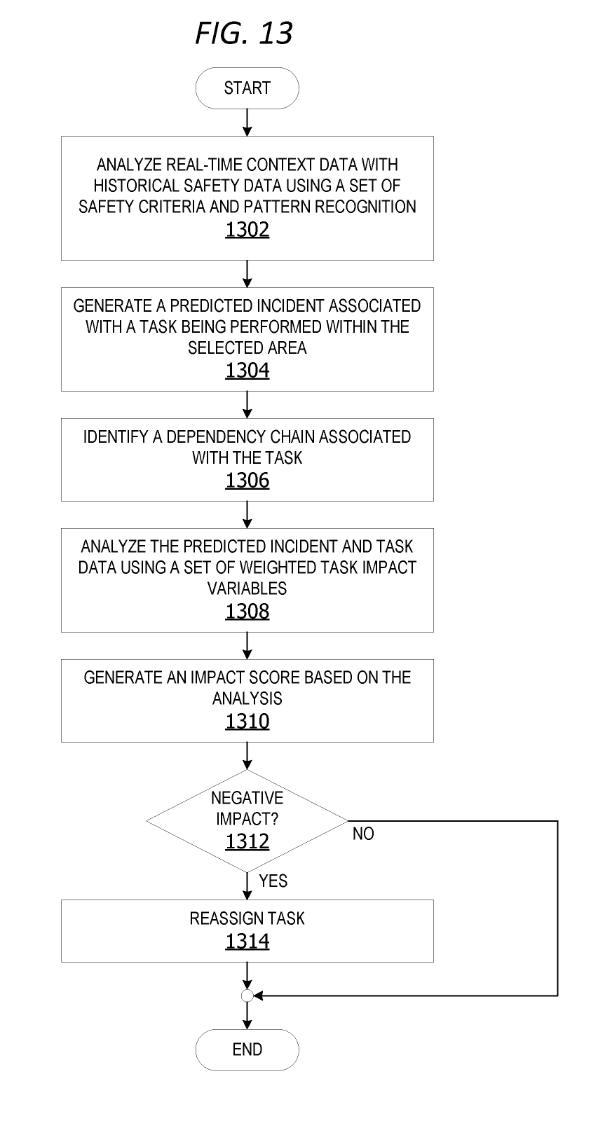

The computer-executable instructions 110 can be performed by the processor 104 or by multiple processors within the computing device 102 or performed by a processor external to the computing device 102. In some examples, the processor is programmed to execute computer-executable instructions 110, such as those illustrated in the figures (e.g., FIG. 11, FIG. 12, and FIG. 13).

The computing device 102 further has one or more computer readable media, such as the memory 106. The memory 106 includes any quantity of media associated with or accessible by the computing device 102. The memory 106 can be internal to the computing device 102 (as shown in FIG. 1), external to the computing device 102 (not shown), or both (not shown). In some examples, the memory 106 includes read-only memory and/or memory wired into an analog computing device.

The memory 106 stores data, such as one or more applications. The applications, when executed by the processor 104, operate to perform functionality on the computing device 102. The applications can communicate with counterpart applications or services, such as web services accessible via a network 112. For example, the applications can represent downloaded client-side applications that correspond to server-side services executing in a cloud.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN accessible to the public, such as the Internet.

The memory 106 further stores one or more computer-executable components. Exemplary components include an impact prediction component 114, that, when executed by the processor 104 of the computing device 102, causes the processor 104 to analyze task-based impact data 116 using a set of safety criteria and pattern recognition variables to generate a predicted incident 118 associated with at least one task being performed within the selected area, such as the task 120.

The task-based impact data 116 is data associated with the task 120, the user 122 assigned to perform the task 120, and the selected area. The task-based impact data 116 can include data such as, but not limited to, real-time context data associated with a selected area and historical safety data.

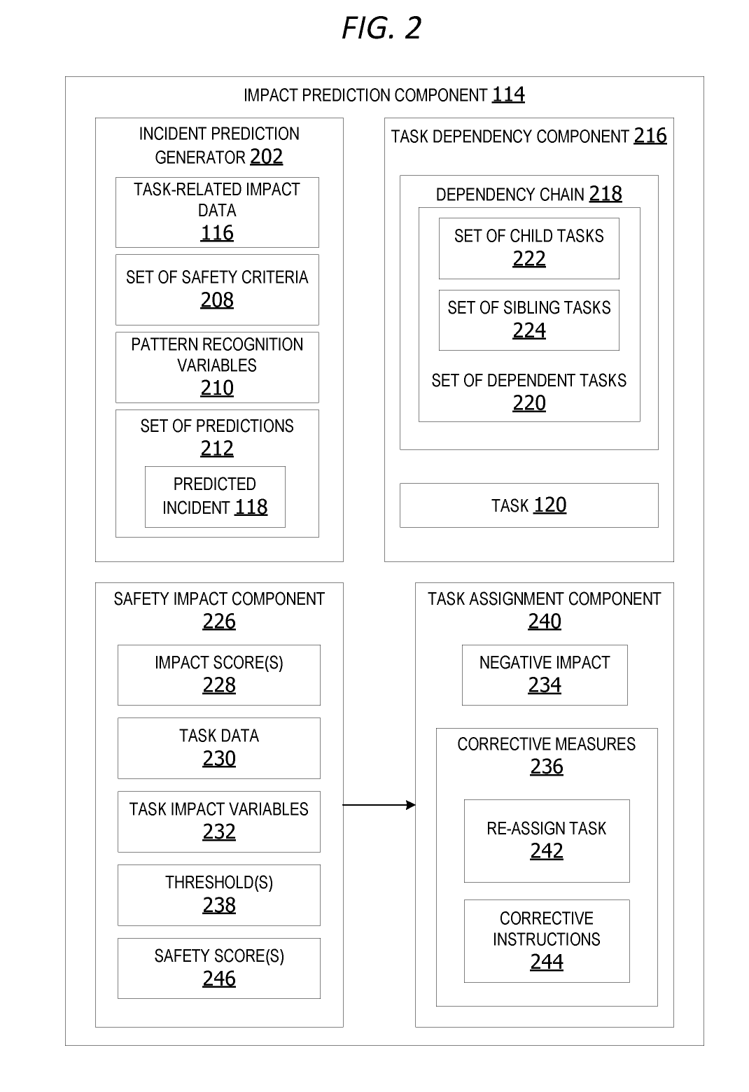

The impact prediction component 114 in some examples generates a dependency chain associated with the task 120. The dependency chain identifies one or more dependent tasks associated with the task 120, such as, but not limited to, the dependency chain 218 in FIG. 2 below. A dependent task can include a child task to be performed after completion of the selected task, a sibling task to be performed concurrently with the selected task, or a parent task which must be completed prior to performance of the task 120.

If the impact prediction component 114 identifies a dependent-task negative impact associated with at least one child task in the set of child tasks as a result of the predicted incident 118, the impact prediction component 114 initiates a set of one or more corrective measures to prevent the predicted incident from occurring and/or mitigate the predicted negative impact of the predicted incident 118 associated with the user's performance of the task 120.

The user 122 is a user assigned to perform the task 120. A user device 124 is associated with the user 122. The user device 124 represents any device executing instructions (e.g., as application programs, operating system functionality, or both) to implement the operations and functionality associated with the user device 124. The user device 124 in this example is implemented as a mobile computing device, such as a cellular telephone, laptop, tablet, computing pad, netbook, gaming device, wearable computing device, and/or portable media player a tablet. A wearable computing device can include a headset, glasses, a smart watch, or other wearable computing device.

The user device 124 in this non-limiting example is running a task manager application 126. The task manager application 126 is a downloadable client application for receiving notifications from the impact prediction component. The user 122 can download the task manager application 126 onto the user device 124 via the computing device 102, an application server, a cloud server, or other source.

The task manager application 126 in some examples is an application executing on a processor for receiving task assignments, predicted incident notifications, corrective instructions, and other data from the computing device 102 via the network 112. The task manager application 126 outputs notifications to the user via an output device, such as, but not limited to, a user interface component, a display screen, an audio output device, a haptic output, or other output device.

The user device 124 optionally includes a graphics card for displaying data to the user 122 and receiving data from the user 122. The user device 124 in some examples includes computer-executable instructions (e.g., a driver) for operating the graphics card. Further, the user device 124 can include a display (e.g., a touch screen display or natural user interface) and/or computer-executable instructions (e.g., a driver) for operating the display. The user device 124 can also include one or more of the following to provide data to the user 122 or receive data from the user 122: speakers, a sound card, a camera, a microphone, a vibration motor, one or more accelerometers, a BLUETOOTH brand communication module, global positioning system (GPS) hardware, and a photoreceptive light sensor. For example, a user can input commands or manipulate data by moving the computing device in a particular way.

In some examples, the task 120 can be reassigned to a different user 128 to prevent the predicted incident associated with performance of the task 120 by the user 122. For example, the task can be re-assigned to a second user having greater experience performing the task, more training than the first user, a better safety record/safety history than the first user, or otherwise possessing credentials indicating the second user is able to perform the task while avoiding the predicted incident.

In these examples, the computing device 102 sends a task re-assignment notification to the user device 130 associated with user 128. In other examples, the impact prediction component 114 assigns the user 128 to assist the user 122 with performance of the task 120 to prevent the predicted incident.

In other examples, the system 100 optionally receives sensor data from one or more sensor devices in a plurality of sensor devices 132 within the selected area. The plurality of sensor devices 132 in some examples includes one or more cameras, one or more radio frequency identifier (RFID) tag readers, one or more scanner devices, one or more pressure sensors, one or more motion sensors, one or more temperature sensors (thermometers), one or more hygrometers, one or more infrared (IR) sensors, one or more proximity sensors, one or more Wi-Fi devices, one or more global positioning system (GPS) devices (GPS transmitters/receives), a beacon transmitter, a beacon receiver, etc.

The plurality of sensor devices 132 in other examples includes one or more autonomous robotic sensor devices. A robotic sensor device is a self-propelled device having a set of one or more wheels, a braking system, a power supply (battery), a set of one or more cameras and an auto-navigation system enabling the robotic device to move autonomously within an area or other space. The robotic sensor device can scan an identification tag or other identifier on an item, a shelf, a wall/post, door or other object to identify the object and/or determine the location of the robotic sensor device. The identification tag or other identifier can be a barcode, an RFID tag, a label, a sign, a beacon, a quick response (QR) code, a watermark, or any other type of identifier. A robotic sensor device can include a single sensor device as well as an array (plurality) of sensor devices generating sensor devices generating sensor data substantially simultaneously as the robotic sensor devices moves throughout the selected area.

The robotic sensor device in other examples generates image data associated with a sign or label and performs image analysis to decode (read) the printed text, label, letters and/or numbers identified in the image data. In other words, the robotic sensor device uses image analysis to read text, lettering, numbers and/or symbols on labels and signage.

The plurality of sensor devices transmits the sensor data generated by the robotic sensor device(s) to one or more computing devices and/or other data stores for aggregation of the sensor data, analysis of the sensor data and/or storage of the sensor data via the network. In this example, the plurality of sensor devices sends the sensor data to the computing device 102. The sensor data can be transmitted as the sensor data is generated or it can be transmitted by the sensor device(s) at a predetermined event, such as, but not limited to, a predetermined time of day, day of the week, aggregation of a predetermined amount of sensor data, receipt of a transmission request, etc.

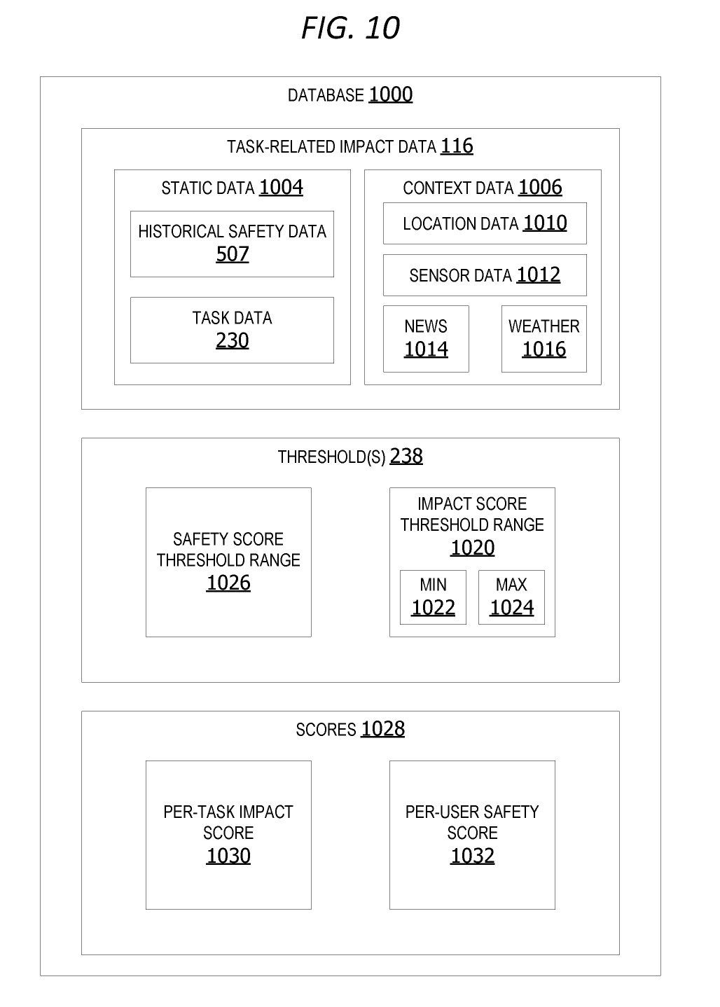

The task-based impact data 116 in some examples includes the sensor data received from the plurality of sensor devices 132, such as, but not limited to, the sensor data 1012 in FIG. 10 below. The sensor data can include, without limitation, image data, audio data, scan data (barcode data), RFID tag data, pressure data, motion sensor data, IR data, temperature data, humidity data, weather data, location data associated with the location of items, location data describing/identifying the location of one or more users, location data describing the location of one or more user devices, or any other type of sensor data. The barcode (scan) data includes UPC coded data, matrix barcode data, QR code data, or any other type of barcode data. In some examples, the sensor data includes daily monitoring data associated with one or more areas and/or one or more items within a monitored area.

The system 100 optionally includes a data storage device 134. The data storage device 134 in some examples includes a set of one or more data storage devices storing data, such as, but not limited to, the task-based impact data 116. The data storage device 134 in other examples include one or more types of data storage devices, such as, for example, one or more rotating disks drives, one or more solid state drives (SSDs), and/or any other type of data storage device. The data storage device 134 in some non-limiting examples includes a redundant array of independent disks (RAID) array. In other examples, the data storage device includes a database.

In other examples, the user interface component 108 includes a graphics card for displaying data to the user and receiving data from the user. The user interface component 108 also optionally include computer-executable instructions (e.g., a driver) for operating the graphics card. Further, the user interface component 108 can include a display (e.g., a touch screen display or natural user interface) and/or computer-executable instructions (e.g., a driver) for operating the display. The user interface component 108 in still other examples also includes one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user can input commands or manipulate data by moving the computing device 102 in a particular way.

In some examples, the system optionally includes a communications interface component 136. The communications interface component 136 includes a network interface card and/or computer-executable instructions (e.g., a driver) for operating the network interface card. Communication between the computing device 102 and other devices occurs using any protocol or mechanism over any wired or wireless connection. In some examples, the communications interface component 136 is operable with short range communication technologies such as by using near-field communication (NFC) tags.

FIG. 2 is an exemplary block diagram illustrating a system for task-based impact predictions including an impact prediction component 114. The impact prediction component 114 includes an incident prediction generator 202. The incident prediction generator 202 analyzes task-related impact data 116, including real-time context data associated with a selected area and historical safety data for one or more users assigned to perform a given task 120 using a set of safety criteria 208 and pattern recognition variables 210 to generate a set of predictions 212.

The task-related impact data 116 in some examples includes data associated with one or more tasks, one or more users, and/or one or more areas associated with the one or more users. The task-related impact data in some examples includes user shift schedules, shift start times, shift end times, daily task assignments, list of users scheduled to work each day, user performance, trip details, shipping schedules, order data, item information, inventory data, item locations, current user locations, scheduled user locations, redundancy in assignments, tasks scheduled to be performed, when tasks are due to be completed, user roles, user qualifications, user duties, user task assignments, task dependency data, user assigned work areas, etc.

The task-related impact data 116 in other examples includes context data describing real-time conditions in one or more areas. The task-related context data in other examples includes the number of users currently within a selected user's assigned area, the number of tasks being performed within the user's assigned area, the number and type of resources being utilized within the user's assigned area, the users and/or resources in transit within the user's assigned area, the weather, floor conditions, absentee users who should be assisting with tasks in the assigned area but are unavailable, scheduling delays, dock-out schedules, and other real-time conditions in the user's assigned area. The floor condition includes, for example but without limitation, data indicating obstructions on the floor, resources on the floor, whether the floor is clean/clear, product spills, liquid spills, whether the floor is wet or dry, etc. The absentee users in some non-limiting examples include those absent on sick leave and/or those absent due to unexpected delays.

The set of predictions 212 is a set of one or more predictions regarding an outcome or impact of incorrect performance of the task 120 or unrecommended method, process, procedure, or technique employed by the user(s) performing the task 120. In this example, the set of predictions 212 includes at least one predicted incident 118 associated with the task 120.

For example, if the task 120 is moving a pallet and the user moving an object utilizes an incorrect number of straps to secure the object to a dolly or other rolling platform for moving the object from one location to another location. The incorrect number of straps occurs if the user utilizes more straps than the recommended number of straps (too many straps) or fewer straps than the recommended number of straps (too few). The incident prediction generator 202 analyzes the number of straps being utilized, the size of the object, the path through which the object is being moved, possible obstructions in the path, the experience level and safety history of the user assigned to move the object, the type of dolly, the expected congestion in the area during the time the object will be moved, as well as any other task-related impact data 116 to determine a likely outcome of the task performance. The likely outcome includes any predicted incidents. A predicted incident 118 is an undesirable outcome, such as a delay in completing the task, damage to equipment, injury, spills, failure to complete the task, delays to other tasks being performed in the same area, delays to other tasks dependent on the task 120, as well as any other type of incident.

The task-related impact data 116 is aggregated in real-time from a plurality of sources. The plurality of sources in some examples includes, without limitation, data stored on a data storage device, such as the data storage device 134 in FIG. 1 and/or sensor data generated by one or more sensor devices associated with the selected area in which the user is performing the task 120.

The task-related impact data 116 also optionally includes task data, user input, user data, and/or data feeds, such as a weather feed, news feed, or other real-time data associated with the environment in which the user is performing the task 120. The user data in some examples includes user qualifications, training, experience, previous task assignments, user safety scores, user injury history, medical conditions, and any other task-related data for a user.

The incident prediction generator 202 analyzes the task-related impact data 116 using a set of safety criteria 208 and/or pattern recognition variables, including but not limited to, image matching, pattern matching, and/or facial recognition to generate predicted incidents. The set of safety criteria 208 includes criteria, rules, guidelines, recommendations, procedures, and instructions for correct performance of tasks, such as, but not limited to, the task 120.

In some examples, the incident prediction generator 202 utilizes image capture and analysis of image data to identify unrecommended actions which can result in occurrence of a predicted incident in real-time. The incident prediction generator 202 analyzes image data to identify angles of a portion of a user and/or a portion of an item, location of a user, location of an item, rotation/motion, states of a user or task, movements of a user, movements of an item, etc. The incident prediction generator 202 utilizes real-time context data and historical data to generate predictive data about observed behavior of users and/or items.

For example, if the task 120 includes unloading pallets off a truck, the set of safety criteria 208 in some non-limiting examples include rules, such as, but not limited to, a rule specifying at least two users working together to unload the truck, a rule advising use of a forklift, a rule mandating a minimum number of straps used to secure a pallet to a dolly or other pallet moving device, a minimum amount of clear/unobstructed space around the unloading area, etc. The safety criteria in some non-limiting examples includes package lift procedures, package handling procedures, clean-up procedures, hazardous materials storage procedures, and other criteria/guidelines for performing tasks in accordance with safety protocols.

For example, if the task 120 is a task for performing routine truck maintenance, the set of safety criteria 208 include, without limitation, a rule specifying a minimum tire pressure and a maximum tire pressure, a rule requiring a minimum time after turning off a truck engine before the oil and other fluids are checked to permit the engine sufficient time to cool, etc.

The set of safety criteria 208 in other examples also specify a minimum level of training, certifications, experience, or other credentials required to perform the task. For example, if the task 120 is replacing a tire on a truck, the set of safety criteria 208 specify a minimum level of experience or training in truck maintenance/repair prior to authorizing a user to perform the task.

The pattern recognition variables 210 is a set of one or more variables for analyzing task-related impact data to generate a predicted outcome. The pattern recognition variables 210 include pattern variables linking certain facts/circumstances (task, temperature, and/or other real-time conditions) with known patterns to predict outcomes which can occur due to that combination of facts/circumstances associated with the task 120.

The pattern recognition variables 210 in some examples include image analysis variables for analyzing image data generated by one or more image capture devices to identify users, objects, and/or other conditions. In other examples, the pattern recognition variables 210 includes facial recognition variables for identifying a user based on facial features captured in image data. The pattern recognition variables 210 optionally include item recognition variables for identifying an item or a type of an item based on item data and image capture data of the item.

The impact prediction component utilizes the set of safety criteria 208 and/or pattern recognition variables 210 to recognize/identify unsafe behavior, potentially hazardous conditions, and/or situations which can interfere with performance of tasks and/or safety of users. In one example, the task 120 is a restocking task associated with a set of shelves and a surface of a floor between the set of shelves is wet, the pattern recognition variables 210 are used to analyze image data and identify the potentially hazardous condition of the wet floor. The impact prediction component calculates a percentage likelihood of delay and/or an amount of time delay associated with restocking the shelves that is likely to occur due to the wet surface based on the current context-data, including temperature. For example, on a hot day the wet floor dries more quickly reducing delay and on a cooler day the floor dries more slowly.

In another example, the incident prediction generator analyzes task-related impact data to identify indicators of a potential incident. In an example, image data is analyzed to identify a lid improperly fastened on a container. The incident prediction generator predicts a potential spill of the contents of the container due to the improperly fastened lid.

A task dependency component 216 generates a dependency chain 218 associated with the task 120 associated with the predicted incident 118. The dependency chain 218 identifies a set of one or more dependent tasks 220 associated with the task 120. The set of dependent tasks 220 in some examples include a set of one or more child tasks 222 dependent upon completion of the task 120. A child task is a task that cannot be started and/or cannot be completed until the parent task is completed.

The set of dependent tasks 220 in some examples include a set of one or more sibling tasks 224. A sibling task is a task that is performed substantially concurrently with the parent task and/or a task that completes substantially simultaneously with the parent task. For example, if building a pallet requires picking two different items, a first task can include picking the first item and a sibling task to the first task can include picking the second item.

A child task can be dependent on multiple parent tasks. In the example above, the task for building the pallet using the two different items to be picked by two different users performing two sibling tasks is a child task dependent on completion of two parent tasks because the pallet build requires successful completion of both parent tasks of picking the first and second items before the pallet build can be completed.

A safety impact component 226 calculates one or more impact score(s) 228 for set of dependent tasks 220 based on an analysis of the generated incident 118 prediction, task data 230 associated with the set of dependent tasks 220, and a set of task impact variables 232. The one or more impact score(s) 228 indicate a degree of negative impact on one or more dependent tasks. For example, if the incident 118 indicates a delay in completion of the task 120 where the user assigned to a dependent task is assigned to take a break during the delay time, there is negligible or no negative impact on completion of the dependent task. Therefore, the impact score(s) 228 for the dependent task in this example is low. The impact prediction component 114 in some examples ignores the predicted incident 118 where little or no substantial negative impact 234 is indicated by the impact score(s) 228.

A negative impact 234 is anything which is expected to interfere or prevent meeting goals, such as task completion goals, safety goals, resource utilization goals, performance goals, quality control goals, etc. A negative impact 234 in some examples includes, without limitation, delays in completing one or more tasks, increased congestion in one or more areas, damaged items, lost items, injury to personnel, or any other negative impact on meeting one or more goals.

However, if the impact score in the above example indicates that a truck departure time is delayed or prevented due to the predicted incident 118, the impact score for the task 120 is higher. If the negative impact 234 on the truck departure time is substantial or unacceptable, the impact prediction component 114 performs corrective measures 236 to prevent or mitigate the predicted incident 118.

The safety impact component 226 in some examples determines whether the negative impact 234 is significant based on one or more threshold(s) 238. The threshold(s) 238 can include a minimum impact score threshold, a maximum impact score threshold, an impact score threshold range, or any other type of threshold. For example, if the impact score for a dependent task is within an unacceptable impact score threshold range, the safety impact component 226 identifies a negative impact 234 for the dependent task. The task assignment component 240 in this example initiates corrective measures 236 with regard to the task 120 to prevent or avoid the negative impact on the one or more dependent tasks associated with the task 120.

The corrective measures can include a re-assign task 242 action and/or a corrective instructions 244 action. The re-assign task 242 action includes re-assigning the task 120 to a different user having greater experience, more training, and/or a better safety record than the first user assigned to the task 120.

In some examples, the impact prediction component 114 generates a task-based safety score for each user in a plurality of users qualified to perform a given task. The safety score(s) 246 include a ranking or indicator of a level of experience, safety history, training, or skill associated with a given task. The higher the safety score the greater the user's experience. In this example, the task assignment component 240 can assign the task 120 to a different user having a higher safety score than the first user assigned to the task to prevent or avoid the incident 118. In other words, a more experienced user can perform the task without any negative impact on other dependent tasks in the set of dependent tasks 220.

In other examples, the task assignment component 240 re-assigns a different user to assist the first user in performing the task 120. In this example, the second user re-assigned to assist with the task 120 is a user having a higher safety score.

In still other examples, the corrective instructions 244 action includes sending additional instructions to the first user instructing the user to start-over, do something differently, perform a skipped step/procedure, take corrective actions, or any other additional instructions to assist the user with performance of the task 120. The corrective instructions 244 are provided to prevent the negative impact on the set of dependent tasks 220. For example, if the incident 118 indicates a predicted delay in loading a truck due to incorrect pallet build, the corrective instructions 244 include instructions for correctly building the pallet to mitigate or lessen the delay.

A task dependency component 216 in other examples generates a dependency chain 218 associated with the task 120. The dependency chain 218 identifies a set of parent tasks associated with the task 120, the set of sibling tasks 224 associated with the task 120, and/or the set of child tasks 222 associated with the selected task 120 assigned to the selected user.

The task data 230 is data associated with a task, such as, but not limited to, data including an identification of a task, location where the task is to be performed, user assigned to perform the task, time to perform the task, time to complete the task, instructions for performing the task, details describing the task, etc.

The task impact variables 232 include dependency chain data and variables/patterns identifying an impact of a predicted incident on one or more dependent tasks in the set of dependent tasks 220. In some examples, the task impact variables 232 include variables indicating that start time of one or more child tasks dependent upon completion of the task 120. The task impact variables 232 include variables for calculating delay in completing the child tasks based on any predicted delay associated with the incident 118 which results in delayed completion or failure to complete the task 120.

In one example, if the selected task 120 is loading pallets onto a trailer, the set of parent tasks can include order-fillers (pickers) building mixed freight pallets and/or haulers moving the mixed freight pallets to a loading area where the loaders perform the pallet loading tasks. In this example, the set of sibling tasks 224 can include loading tasks assigned to other loaders that also assist with loading the mixed freight pallets onto the trailer at the same time. The set of child tasks 222 in this example includes a validation task for quality control/inspection of the mixed freight pallets after they have been loaded onto the truck. After validation, the loaded trailer is ready for departure. The selected tasks and the sibling tasks for loading the pallets onto the trailer are not performed until the parent tasks for building the pallets and moving the pallets to the loading area are completed. Likewise, the child tasks for validating the loaded pallets on the trailer cannot be performed until the loading tasks are completed.

In other examples, the task assignment component 240 generates a break schedule for each user assigned to a task in a dependency chain based on predicted delays in task completion due to a predicted incident associated with a parent task. The task assignment component 240 in these non-limiting examples generates a per-user break schedule for each user in a plurality of users assigned to perform at least one dependent task during a given time-period within a selected area during the given time-period when completion of the parent task is expected to be delayed. The task assignment component 240 assigns break times to users based on delays resulting due to predicted incidents which are not severe enough to warrant re-scheduling/re-assigning tasks.

In some examples, the task assignment component 240 analyzes the task-related impact data using the one or more task impact variables 232, including rules specifying a break frequency for each user, a break length for each user, and/or user preferences for break time, break frequency, and/or break length to determine when to assign breaks to users performing dependent tasks.

The task impact variables 232 includes one or more factors for determining an impact of a predicted incident on one or more other tasks, including impact on other user's schedules, due dates, completion of the other user's tasks, number of users in a congested area or an area predicted to become congested, completion of dependent tasks, user idle time, idle time by other users, etc. The impact variables are used to determine whether to perform corrective actions or whether to take no action with regard to one or more predicted incidents/outcomes. In some examples, the impact variables include laws, break scheduling rules, task completion goals, congestion avoidance, and other variables associated with a plurality of tasks and a plurality of users performing the tasks.

The task impact variables 232 in some examples include a rule for giving a higher break priority to a user in a congested area and a lower user break priority to a user in an uncongested work area. Likewise, if a work area is not congested now but is predicted to become congested in an hour due to a predicted incident, the task assignment component 240 assigns a low break priority to the user now and assigns a higher break priority to the user for the time-period in an hour from now when the user's assigned area will become congested.

The task assignment component 240 can assign a higher break priority to a user assigned to a dependent task if the parent task will not be completed when the break time occurs. The user gets a lower break priority if the parent task will be complete at the time the break occurs. In other words, the task assignment component 240 avoids assigning a user scheduled to perform a dependent task to take a break during a time when the parent task is expected to be completed.

The task assignment component 240 in other examples assigns users to tasks and breaks based on task-related impact data indicating real-time conditions within the user's assigned area. The task assignment component 240 selects a start time for the per-user customized break time that will send the selected user on break when the user's break will reduce or minimize negative impacts/delays in task completion associated with predicted incidents in the dependency chain and/or minimize delays to other dependent tasks. Moreover, customizing break start time to each user based on real-time conditions in the user's work area and/or dependency chain further reduces task dependency chain delays, prevents congestion from occurring in one or more areas, minimizes time one or more users are idle, and/or improves task performance.

The impact prediction component 114 in other examples determines an impact of a predicted incident associated with a parent task in a dependency chain by comparing an impact score for a predicted incident with an impact threshold value, such as a threshold value in the threshold(s) 238.

The impact threshold value is an indicator of whether a negative impact of a given predicated incident is sufficient to implement corrective measure and/or whether the negative impact is negligible enough to disregard/take no action to prevent the predicted incident. The impact threshold value can be a default threshold or user-defined threshold. The impact threshold value can be a numerical value, a percentage, a range of values, or any other type of threshold. In some examples, the threshold is a value in a range from one-to-ten and the predicted incident impact score is a value between one and ten. For example, the impact threshold can have a value of five. If the impact score is five or lower, the impact is a minimal impact. If the impact score is six or higher in this example, the impact associated with the predicted incident is great enough to warrant taking corrective measures to prevent the predicted incident.

The impact score(s) 238 indicate the degree if negative impact on one or more dependent tasks if the predicted incident 118 does occur. For example, if the predicted incident 118 would delay or prevent a truck from departing (dock-out) on time, the break impact score would be a score indicating a strong/higher negative effect. If a score of one indicates a negligible negative impact on one or more dependent tasks in the set of dependent tasks 220 and a score of ten indicates a strong/higher negative impact, the impact score in this example would be high (9 or 10) because achieving scheduled dock-out times is a very high priority goal.

The impact threshold value of the threshold(s) 238 can be a single value as well as a range of values. For example, if the impact score falls between a maximum value and a minimum threshold value, corrective actions are initiated by the impact prediction component 114. If the impact score falls outside the threshold range, the impact prediction component 114 does not perform any corrective measures.

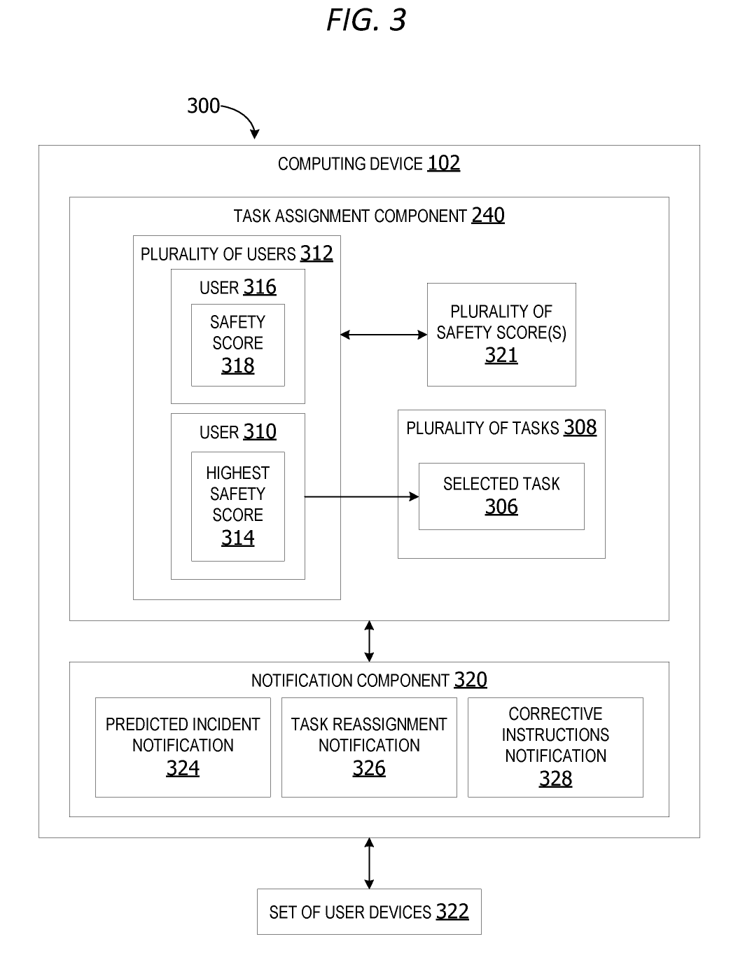

FIG. 3 is an exemplary block diagram illustrating a system for task-impact based task management. The system 300 includes a computing device 102 implementing a task assignment component 240 for assigning tasks to users based on predicted task-impacts on dependent tasks in a task dependency chain. The task assignment component 240 assigns a selected task 306 in a plurality of tasks 308 to a first user 310 in a plurality of users 312 having a highest safety score 314 associated with the selected task 306. The selected task 306 is a task such as, but not limited to, the task 120 in FIG. 1 and FIG. 2.

The plurality of users 312 is a group of two or more users available to perform the selected task 306 and qualified to perform the selected task 306. If there are multiple qualified users available to perform a given task, the task assignment component 240 in some examples assigns the task to the user having the highest safety score 314 for that given task.

The plurality of users 312 in this example includes a user 316 and the user 310. A safety score 318 is assigned to the user 316. The safety score 318 indicates the user's level of experience, training, and/or safety history associated with the same or similar task as the selected task 306. For example, if the selected task 306 is a task to drive a truck in winter weather, the safety score 318 can indicate a degree of driving experience in winter weather, number of years of truck driving experience, amount of winter weather training, etc. In this example, the user 310 has greater experience, training, and/or safety record associated with winter weather driving. Therefore, the task assignment component 240 assigns the selected task 306 to the user 310 where both users 310 and 316 are available to perform the task 306 (drive the truck in the current winter weather conditions).

In some non-limiting examples, the task assignment component 240 utilizes a plurality of safety scores 321 for the plurality of users 312 to assign all tasks. In other examples, the task assignment component 240 utilizes the safety scores to re-assign tasks and/or determine whether to perform corrective measures if a negative impact is predicted for a parent task.

For example, if a negative impact on one or more dependent tasks is predicted based on a predicted incident associated with performance of the selected task by a first user, the task assignment component determines whether the safety score for the first user is within an acceptable threshold range. If the safety score is within the threshold range indicating the assigned first user has sufficient experience, training, and/or acceptable safety record regarding performing tasks of the same type as the selected task 306, the task assignment component 240 sends corrective instructions to the first user instructing the first user in corrective measures to be taken by the first user to avoid/mitigate the predicted negative impact.

In other examples, if the safety score for the assigned first user is outside the threshold safety score range, the task assignment component 240 can assign a second user to assist the first user with completion of the selected task 306. In some examples, the second user can have a higher safety score than the first user.

In still other examples, if the safety score for the assigned first user is outside the threshold safety score range, the task assignment component 240 re-assigns the selected task 306 to a second user having a higher safety score. In these examples, the first user's assignment to the selected task 306 is cancelled or rescinded.

The impact prediction component in some examples includes a notification component 320 for sending notifications to one or more user devices in a set of user devices 322 associated with one or more users, such as, but not limited to, the user device 124 and/or the user device 130 in FIG. 1. The notification component 320 in some examples sends a predicted incident notification 324 to at least one user device associated with the user assigned to perform the selected task 306.

The predicted incident notification 324 can include an identification of the predicted incident, an identification of the selected task 306, and/or an identification of the predicted negative impact associated with the predicted incident. In some examples, the predicted incident notification 324 includes one or more recommended corrective actions to be taken which can prevent and/or mitigate the predicted negative impact.

A task reassignment notification 326 can be sent by the notification component 320 to notify the assigned first user and/or a second user that the second user has been assigned to assist the first user with completion of the selected task 306. The task reassignment notification 326 can include a notification that the first user is unassigned from the selected task and a second user has been re-assigned to complete the selected task 306.

The notification component 320 in other examples sends a corrective instruction notification 328 including instructions for the first user to perform the selected task while avoiding or mitigating the predicted incident. The corrective instructions notification 328 can be sent to the first user assigned to perform the task and/or a supervisor of the first assigned user.

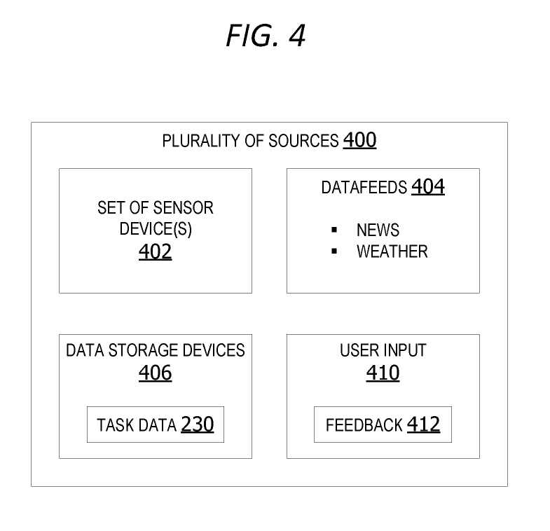

FIG. 4 is an exemplary block diagram illustrating a plurality of sources 400 of task-based impact data. The plurality of sources 400 includes a set of one or more sensor device(s) 402, one or more data feeds 404, one or more data storage devices 406, and/or user input 410. In other examples, the plurality of sources 400 includes social media sources, user input, or other sources. In some examples, the task-related impact data is aggregated by the impact prediction component from the plurality of sources 400 via a network connection, such as the network 112 in FIG. 1.

The set of one or more sensor devices 402 includes one or more devices, such as one or more of the sensors in the plurality of sensor devices 132 in FIG. 1. A sensor device in the set of sensor devices 402 can include, for example but without limitation, image capture device(s), microphone(s), global positioning system (GPS) sensors, RFID tag readers, UPC readers, matrix barcode readers, pressure sensors, a robotic (autonomous) sensor device, etc. The data feeds 404 can include weather service data feeds, news service data feeds, or other wire feeds.

The data storage devices 406 includes a set of one or more data storage devices for storing data, such as the task data 230. The set of data storage devices 406 optionally include a data storage device, such as, but not limited to, the data storage device 134 in FIG. 1. The data storage devices 406 can include one or more rotating disks drives, one or more solid state drives (SSDs), and/or any other type of data storage device. In some examples, the data storage devices 406 includes one or more redundant array of inexpensive disks (RAID) arrays. The data storage devices 406 optionally include one or more databases and/or files storing task-related impact data.

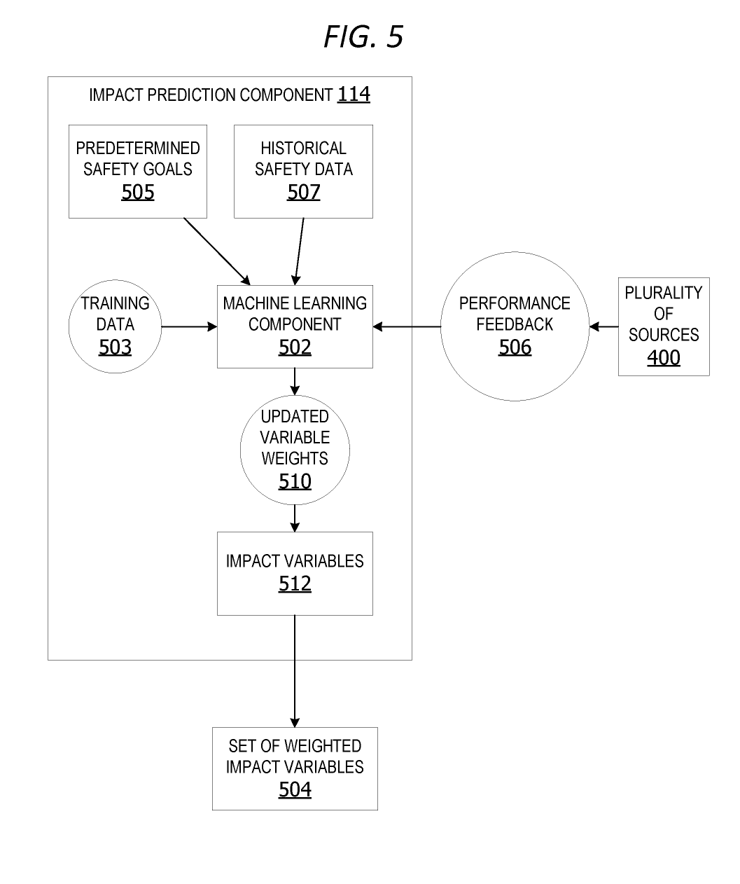

FIG. 5 is an exemplary block diagram illustrating a machine learning component 502 for generating a set of weighted impact variables 504. The impact prediction component 114 optionally includes the machine learning component 502 for analyzing training data 503, predetermined safety goals 505 feedback 506, and/or historical safety data 507 to generate updated variable weights 510. The updated variable weights 510 are added to one or more impact variables 512 to generate the set of weighted impact variables 504.

The training data 503 in some examples include historical task-related impact data, task incident impact trends/patterns, etc. The training data 503 in other examples include baseline input of safe behaviors and/or recommended behaviors used to train the machine learning component 502. The training data 503 can include images/video of proper lifting and/or improper lifting, driving of forklifts, proximity to conveyor system, proper material handling, sequence of steps for performing a task, etc.

In an example, the training data 503 includes a base profile. The base profile can be generated using task-related impact data from one or more other locations, location-based timestamps to identify types of work being performed at specific locations and times in a given location, identify incidents, and build the base profile.

The predetermined safety goals 505 includes task completion goals, such as, but not limited to, time of task completion, quality of completed task, etc. The historical safety data 507 is data associated with previous task-related incidents and their impacts on other dependent tasks. The historical safety data 507 can include prior incidents associated with a given user and/or safety review records for one or more users.

The machine learning component 502 in some examples includes algorithms for analyzing data and generating data-driven predictions based on prediction modeling and pattern recognition. The machine learning component 502 in other examples also receives performance feedback 506 from a plurality of sources 400. The performance feedback in some examples includes feedback regarding user safety, task completion quality, performance issues, etc. The plurality of sources 400 can include performance evaluations, medical conditions, injury/accident histories, work schedules, deliveries, inventory, and/or impact data.

The machine learning component 502 in some examples utilizes the performance feedback 506 to generate the updated variable weights 510. The updated variable weights 510 are utilized by the impact prediction component 114 to generate more accurate and dependable break impact scores used to evaluate task performance by assigned users, predict incidents associated with the task performance, identify negative impacts on dependent tasks, and determine whether corrective measures should be performed to mitigate the negative impacts. In other words, the machine learning component 502 analyzes performance feedback 506 to adapt, refine, and improve generation of predicted incidents associated with tasks which have not yet been performed or are currently being performed but not yet completed.

In other examples, the machine learning component 502 receives input including the performance feedback, trip details and schedules, worker assignment details, as well as other task-related impact data. The machine learning component 502 analyzes this input using pattern recognition and prediction modeling to predict a task flow timeline and predict future patterns of congestion and predict task status at various points during task performance, including predictions of the number of users in each area, whether the travel path will be clear, number of users/resources predicted along the travel paths, amount of foot traffic on travel paths, movement of resources, potential delays, problems/issues likely to occur, predicted inventory for all slots at scheduled or proposed break times and/or inventory for all slots during break intervals, etc. These predicted patterns of congestion are utilized to evaluate the effect of predicted incidents on dependent tasks and identify corrective measures, such as generating corrective instructions, changing task assignments, re-assigning tasks, changing/modifying user break schedules, and/or generating/outputting predicted incident reports regarding uncompleted tasks in a dependency chain.

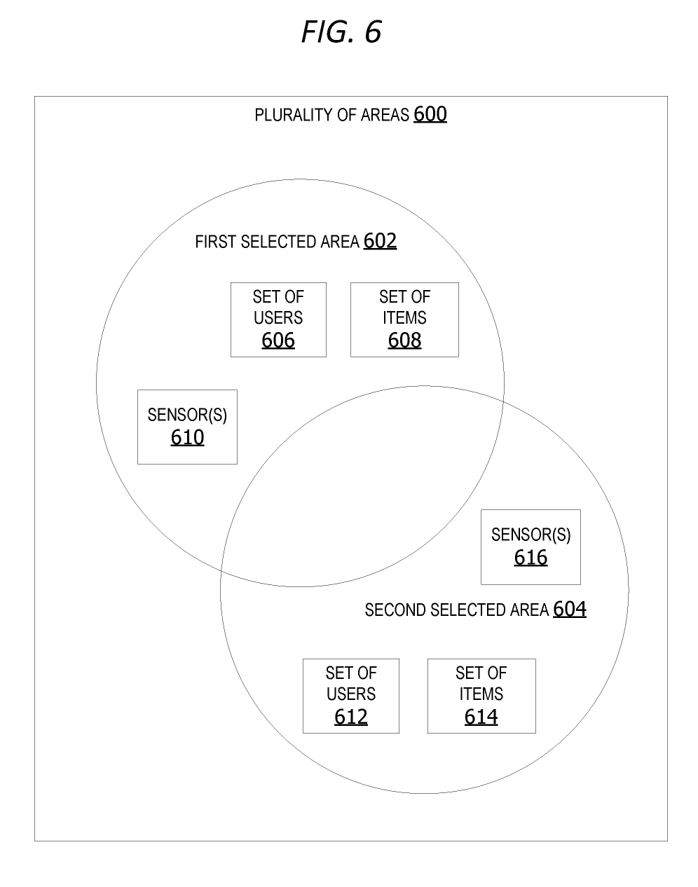

FIG. 6 is an exemplary block diagram illustrating a plurality of areas associated with a plurality of users assigned to perform a plurality of tasks. The plurality of areas 600 includes areas associated with one or more users assigned to perform one or more tasks. In some non-limiting examples, the plurality of areas 600 includes two or more areas in a distribution center, a store, a warehouse, or other area for storing and/or displaying items.

In this non-limiting example, a first selected area 602 includes a set of one or more users 606, a set of one or more items 608, and one or more sensor(s) 610. A second selected area 604 can include a set of users 612, a set of items 614, and one or more sensor(s) 616.

A set of items 608 includes vehicles, equipment, inventory, supplies, boxes, crates, pallets, or other items. For example, the set of items 608 can include a forklift, a truck, a trailer, a computer, a printer, a conveyor belt, a refrigerated trailer, a dolly, or any other type of equipment.

The sensor(s) 610 and/or the sensor(s) 616 includes one or more sensor devices, such as the plurality of sensor devices 132 in FIG. 1 and/or the set of sensor devices 402 in FIG. 4. A sensor device in the sensor(s) 610 and/or the sensor(s) 616 can include, without limitation, a camera, a scanner, an RFID tag reader, a pressure sensor, weight sensors (scales), proximity sensors, temperature sensors (thermometers), motion sensors, IR sensors, or any other type of sensor device. The cameras can include stationary cameras, mobile cameras, as well as cameras included within user devices associated with one or more users.

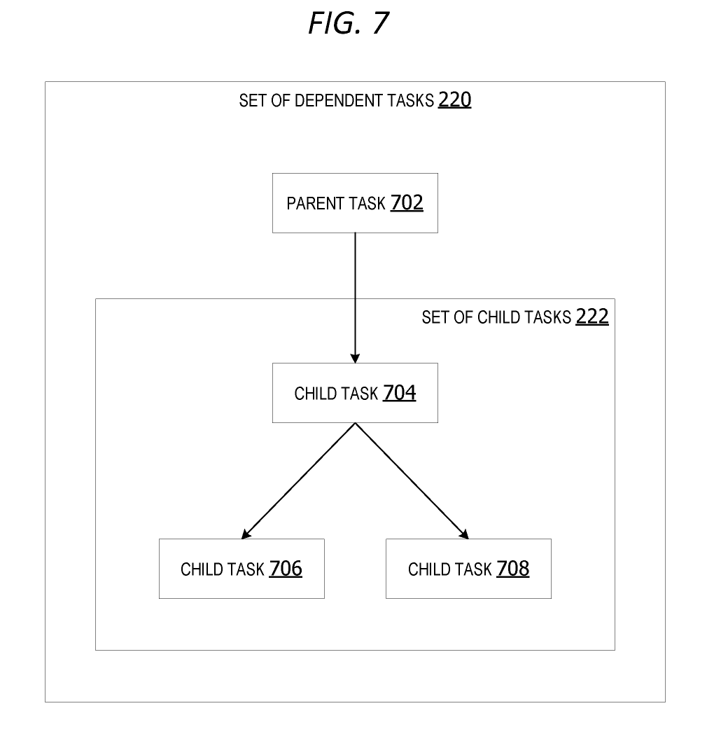

FIG. 7 is an exemplary block diagram illustrating a set of dependent tasks associated with a selected task, such as, but not limited to, the selected task 306 in FIG. 3. The set of dependent tasks 220 is a set of one or more tasks in a dependency chain which includes a parent task 702 assigned to at least one user. In this non-limiting example, the parent task 702 is associated with one or more child tasks which are dependent upon completion of the parent task 702. In other words, a child task cannot be performed until the parent task is completed.

In this example, the parent task 702 is a parent task to child task 704, child task 706, and child task 708. The child task 704 is also a parent task to child task 706 and child task 708. The child task 706 and child task 708 are dependent on both child task 704 and parent task 702. Initiation of the child task 704 requires completion of the parent task 702. If the child task 704 is assigned to a first user and the parent task 702 is assigned to a second user, the impact prediction component utilizes the dependency chain to determine impact of a predicted incident for the child task. The negative impact data is utilized to improve task completion and reduce work latency time for users assigned to the set of child tasks 222.

The set of child tasks 222 can include sibling tasks, such as child task 706 and child task 708. Sibling tasks are tasks which are performed concurrently by two or more users. In an example, a trailer unloading task includes unloading tasks that require two users to simultaneously unload the pallets. In this example, each of the two users is assigned a sibling task to be performed by them simultaneously. The two users work concurrently to accomplish the task.

If the parent task 702 fails to complete as scheduled, the users assigned to the child tasks 704, 706, and/or 708 can be idle and unable to proceed with performance of their assigned tasks until the parent task is completed. Therefore, the impact prediction component attempts to predict any incidents associated with the parent task 702 and/or the child task 704 which can cause a negative impact on performance/completion of child tasks 706, 708, and/or 704. If the child tasks are negatively impacted, the impact prediction component identifies corrective measures which can prevent or mitigate the negative impact on the child tasks. The impact prediction component in some examples recommends performance of the corrective measures via a predicted incident notification. In other examples, the impact prediction component performs the corrective measure via output of corrective instructions and/or re-assignment of one or more tasks.

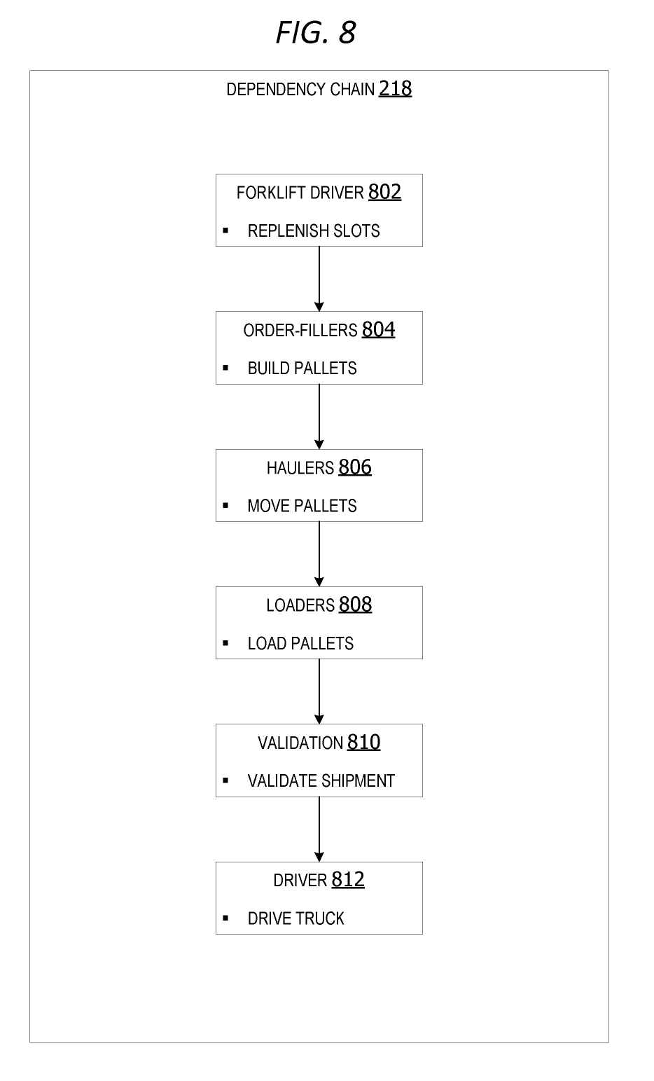

FIG. 8 is an exemplary block diagram illustrating a dependency chain. The dependency chain 218 in this non-limiting example includes a forklift driver 802 to replenish slots, order-fillers 804 to build one or more mixed freight pallets, haulers 806 to move the pallets to a loading dock area, loaders 808 to load the pallets onto a truck or trailer, a validation 810 manager to validate the shipment, and a driver 812 to driver the truck pulling the trailer to a destination. An order-filler can also be referred to as a picker.

Replenishment lift drivers ensure pick slots are full for order-fillers who are building pallets. Order-fillers build pallets which are loaded onto trucks by loaders. Loaders ensure trucks are loaded timely, so trailers leave the yard on schedule. Most of the tasks in the dependency chain are dependent on one or more other tasks in the chain.

A delay or other incident associated with a task in the chain can result in interference or delay with performance/completion of other tasks in the dependency chain. For example, if there is a predicted incident associated with a loading task, the incident can have a negative impact on a truck driver task dependent on completion of the loader task. An order-filler task incident can negatively impact a loader task waiting for the order-filler to complete order-filling. Likewise, an incident associated with a lift driver task can negatively impact one or more order-fillers waiting for the lift driver to replenish one or more slots. If a lift driver related incident causes order-fillers to be idle, this incident has a negative impact on the order-filler task(s), loader tasks, and driver tasks in the dependency chain.

In one example, the impact prediction component identifies an order-filler predicted to encounter congestion or another issue/incident associated with completion of the order-filler task. The impact prediction component calculates an impact score for each dependent task in the chain. In this example, there is an impact score for the haulers, loaders, validation, and driver tasks. If the impact scores for the dependent tasks indicate an unacceptable degree of negative impact within the dependency chain, the impact prediction component initiates corrective measures. The corrective measures can include outputting recommendations to prevent the incident, corrective instructions to the order-fillers, sending users assigned to dependent tasks on break during the additional time required to complete the parent task, assignment of additional users to assist with performance of the order-filler tasks, and/or re-assignment of the order-filler task(s) to one or more different users.

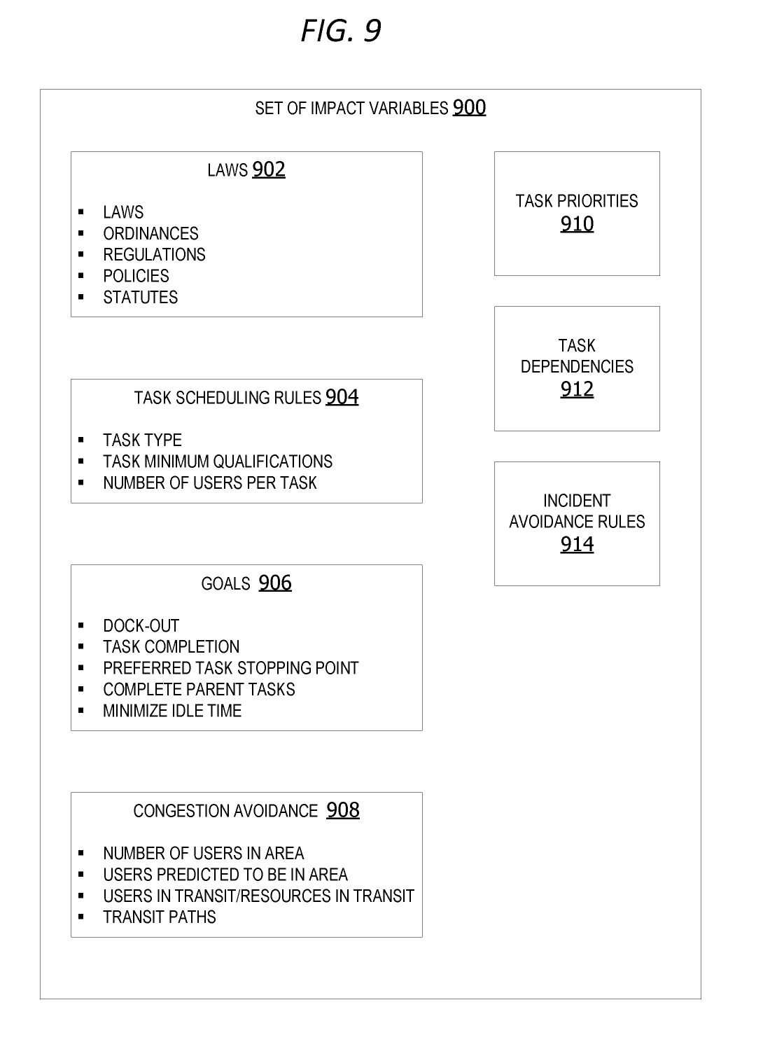

FIG. 9 is an exemplary block diagram illustrating a set of impact variables 900. The set of impact variables 900 in this non-limiting example includes laws 902, task scheduling 904, goals 906, and/or congestion avoidance 908. The set of impact variables 900 can also optionally include task priorities 910, task dependencies 912, and/or incident avoidance rules 914.

The laws 902 can include federal, state, or local laws, statutes, city ordinances, regulations, labor laws for a region, certification/training requirements, and/or task and break assignment policies. The task scheduling 904 variables can include task data, task type information, minimum task qualifications, minimum training requirements for a task, a minimum number of users to safely perform a task, a minimum level of experience required to perform a task, etc. For example, the set of impact variables 900 can include a variable specifying a user receive a minimum of three hours training prior to being assigned to the task. A variable can also specify a minimum length of time for performance of the task. For example, a task scheduling variable can indicate that a user should be permitted a minimum of twenty minutes for a display restocking task.

The goals 906 can include a dock-out variable. Dock-out is a due date or scheduled time for a loaded truck to depart from a distribution center. The variables can specify that a predicted incident should not delay dock-out time or prevent a scheduled dock-out. If dock-out can be delayed or prevented by an incident, corrective measures should be taken to prevent the predicted incident.

The goals 906 can also include task completion goals. For example, variables can indicate that corrective measures should be implemented to prevent a predicted incident if it is predicted to interfere with completion of a dependent task where the corrective measures can prevent or mitigate the negative impact associated with the predicted incident.

Yet another goal can include minimizing idle time by users assigned to perform one or more dependent tasks. For example, if a predicted incident associated with a parent task is predicted to leave users assigned to perform child tasks idle, corrective measures are taken to prevent the predicted incident or mitigate the negative impact of the predicted incident if the negative impact cannot be completely prevented.

Congestion avoidance 908 variables are variables to limit congestion in a given area as a result of a predicted incident. For example, if an incident which delays unloading of a truck is predicted to increase congestion and/or increase obstructions within an unloading area, corrective measures are performed by the prediction impact component to prevent the congestion. The corrective measures can include reassigning users scheduled to perform tasks in the unloading area, assigning additional users to assist with unloading the truck, sending users working in the unloading area on break to reduce congestion, and/or avoid sending users on break if the users will be moving through congested areas in the course of taking a break.

Congestion avoidance variables can include variables specifying a maximum number of users in an area, a maximum number of items in an area, a minimum amount (square footage) of open unobstructed space, and/or a maximum number of users or resources in transit through an area or along a transit path predicted to be congested as a result of a predicted incident.

The task priorities 910 indicate which tasks have precedence over other tasks. For example, truck loading can be given precedence over truck unloading tasks. In another example, truck maintenance tasks can be given precedence over janitorial/cleaning tasks. The task priorities are utilized to determine the level of negative impact due to a predicted incident. For example, if a predicted incident can delay a janitorial/cleaning task, the predicted negative impact can be determined to be minimal/negligible. However, if the predicted incident would delay unloading a refrigerated truck having a high priority, the impact prediction component identifies the predicted negative impact as a higher impact indicating performance of corrective measures to prevent the negative impact.

Task dependencies 912 refer to the dependencies of child tasks and sibling tasks upon completion of one or more parent tasks in a dependency chain. The incident avoidance rules 914 include variables specifying actions which can be taken to mitigate or avoid predicted incidents. The actions can include sending a user on a break to mitigate delays, sending recommended corrective actions to one or more users, re-assigning users to one or more tasks, and/or outputting corrective instructions to one or more users.

The impact variables can be weighted using weights, such as the updated variable weights 510 in FIG. 5. The weights indicate which variables take precedence over other variables. The weight(s) indicate the importance of each task impact variable relative to every other variable in the set of task impact variables. The weight(s) indicate how much weight or influence each factor has when determining a degree of negative impact on another task.

In some examples, laws are given the greatest weight. The laws can include statutes, regulations, ordinances, etc. If laws require a user break to occur within a given time frame and a predicted incident would delay the break, the impact prediction component initiates corrective measures to prevent the delay/enable the break to occur as scheduled regardless of other variables such as congestions, dependency chain delays, etc.

The weights in other examples give the second greatest weight to task scheduling rules. In still other examples, laws and task scheduling rules are given equal weight. Laws and task scheduling rules are given greatest weight over task completion goals and congestion avoidance in other examples.

In one non-limiting example, weights can be given in percentage values. Laws can be given a weight of forty percent, task scheduling rules can be given a weight of thirty percent, while task completion goals are given twenty-percent weight and congestion avoidance is given a ten-percent weight.

In other examples, trailer dock-out time is a first priority variable that takes precedence over other lower priority variables. The dock-out time is calculated based on the latest time that a trailer should leave a location, such as a distribution center, in order to meet transportation or delivery deadlines. The dock-out time can be determined by noise ordinances, receiving shift schedules, inventory guidelines (must receive-by times), urban traffic avoidance, etc. On occasion, if a dock-out time has elapsed without the trailer leaving the distribution center, the trailer will have to wait until the next day to be delivered. Unless required by laws 902, such as labor laws, the impact prediction component does not prioritize potential efficiency gains over missing a dock-out time.

In other examples, task scheduling 904, goals 906, and/or congestion avoidance 908 are second priority variables. For example, variables associated with downtime of users assigned to dependent tasks, such as order-filler and loader downtime. The impact prediction system can prioritize order-filling task assignments and breaks to minimize downtime by associates based on supply chain dependencies. For example, a goals variable can specify that corrective action should be taken to prevent a predicted incident associated with a lift driver's task if an order-filler is waiting for the lift driver to replenish a slot to avoid leaving the order-filler idle while the lift driver's task is delayed. Likewise, the variables can specify that an order-filler's task can be delayed by a predicted incident if a loader can be assigned to other tasks during the delay time such that completion of tasks in the dependency chain do not negatively impact laws, scheduling, goals, priorities, congestions, etc.

FIG. 10 is an exemplary block diagram illustrating a database 1000 storing task-related impact data 116. The impact prediction component gathers task-related data from a plurality of sources, such as the plurality of sources 400 in FIG. 4 and/or FIG. 4. The task-related impact data 116 includes static data 1004 and context data 1006. The static data 1004 includes work schedules, user shifts, task assignments, historical safety data 507, task data 230, logs, inventories, dependency chain data for various tasks, and user work area assignments.

The context data 1006 is data associated with dynamically changing conditions associated with a selected area. The context data 1006 includes data such as current location data 1010 for users and/or items, sensor data 1012 generated by one or more sensor devices, news 1014, current weather 1016, weather forecasts, seasonal changes, non-operational vehicles or other equipment, liquid spills, pallet spills, damaged items, task completion delays, obstructions within a work area or on a path used by people or vehicles, congested areas, and/or unscheduled absence of one or more users due to illness or taking a sick day.

The impact prediction component generates predicted incidents and/or predicted negative impact on dependent tasks due to predicted incidents based on the static data 1004 and the context data 1006, enabling predictions based on the real-time changing conditions within each user's assigned area and predicted future conditions in each user's assigned area. The task-related impact data 116 associated with the selected user, the task assigned to the selected user, and the dependency chain for the assigned task, are analyzed to determine the current conditions and to predict what the conditions will likely be in the future.

The impact prediction component in some examples determines a corrective action to take in response to a predicted incident that is predicted to minimize or reduce congestion, minimize or prevent delays in task completion, adhere to break scheduling rules, and/or minimize delays in the task dependency chain. Task dependency chain delays can include worktime latency of users assigned to a dependent task as well as delays in completing dependent tasks.

The break time-span is the span of time from the break start time until the break end time. The break time-span is a span of time during which the selected user is absent from the user's assigned area. For examples, the user's assigned area can be very congested in the present but anticipated to become less congested in an hour. In this example, the impact prediction component can assign a user to take a break at a per-user break time that includes a per-user break start time and an end time which occurs during a predicted delay in completion of a parent task to prevent the user assigned to a dependent task from being left idle during the predicted delay.

In another example, a predicted incident can increase congestion in a given area. The impact prediction component can determine a given user's assigned area is uncongested in the present, but the area is predicted to become more congested in one-hour due to the predicted incident associated with another task to be performed in the area. In this example, the task assignment component can schedule the given user to take a break in one-hour when the area is predicted to become congested. However, if the break scheduling rules require the user to take an un-used break within half-an-hour, the task scheduling component generates a per-user break time starting within half-an-hour despite any predicted congestion occurring later in the day because the break scheduling rules take precedence over minimizing congestion/mitigating negative impact of the predicted incident.

In other examples, if a user is in an uncongested area but there are one or more dependent tasks waiting on the assigned task to be completed, the user's break is delayed until the assigned task is completed if the delay is allowed by the break scheduling rules. If the task scheduling rules require the user to take a break immediately, the break will be schedule despite the dependencies, the lack of congestion, or incomplete task status because the break scheduling rules take precedence over mitigating congestions, completing tasks, or chain dependency.

In some examples, if the user's assigned task is incomplete, the user's next un-used break is due, and there is a second user assigned to a dependent task that is waiting for the first task to complete, the task assignment component schedules the first user and the second user to the same break time to minimize the second user's wait/idle time.

The database 1000 in other examples includes one or more threshold(s) 238. The threshold(s) 238 can include a safety score threshold range 1026 and/or an impact score threshold range 1020. A threshold range can include a minimum (MIN) 1022 threshold value and a maximum (MAX) 1024 threshold value.

The impact prediction component in some examples compares a per-task impact score 1030 with the impact score threshold range 1020 to determine whether the negative impact predicted to occur as a result of a predicted incident associated with a parent task is sufficient to necessitate corrective measures.

In other examples, the database 1000 includes one or more scores 1028. The scores 1028 can include at least one per-task impact score 1030. The per-task impact score 1030 indicates the impact of the predicted incident with regard to one or more variables in the set of weighted impact variables. For example, a low impact score for a predicted incident can indicate the predicted incident is unlikely to result in any latency or idle time for any user due to task dependencies.

The per-task impact score 1030 can be a numerical value, a percent value, or any other score. For example, if impact scores are provided in a range from zero to one-hundred where a score of zero indicates a positive impact (no negative impact on dependent tasks, other users, congestion, etc.) and a score of one-hundred indicates a maximum negative impact on other tasks, users, and/or congestion, then a score of fifty indicates a neutral impact.

In other examples, the per-task impact score 1030 can be a value on a scale from one to five where a score of five is a best score indicating a negligible negative impact or no negative impact. An impact score of one in this example indicates a greatest degree of negative impact. In these examples, a score of three indicates a mid-range value for negative impact.

In some examples, a different per-task impact score is generated for each dependent task in a dependency chain. For example, if an incident is predicted with regard to an order-filler task, a unique per-task impact score is generated for child loader tasks and another unique impact score is generated for a child pallet-build task dependent on the order-filler task.

In other examples, a different per-user safety score 1032 is generated for each user and each different task or type of task. For example, if a task is a loader task, each user qualified to perform the loader task is assigned a unique per-user safety score 1032 indicating the user's safety ranking/qualifications with regard to performing the same or similar loader tasks.

FIG. 11 is an exemplary flow chart illustrating operation of the computing device to assign a user to perform a task based on per-user safety scores. The process shown in FIG. 11 can be performed by an impact prediction component executing on a computing device, such as the computing device 102 in FIG. 1 and/or FIG. 3.

The process begins by identifying a set of users qualified to perform a task at 1102. The set of users is a set of one or more users qualified to perform the task, such as the set of users 612 in FIG. 6. A safety impact component generates a per-task safety score for each user at 1104. The safety impact component is a component such as the safety impact component 226 in FIG. 2.

The task assignment component assigns the task to the user in the set of users having a highest per-task safety score at 1106. The task assignment component is a component for assigning or re-assigning users to tasks, such as the task assignment component 240 in FIG. 4. The per-task safety score is a score indicating a degree or qualification ranking of a given user regarding a task or type of task, such as the safety score 318 in FIG. 3 and/or the per-user safety score 1032 in FIG. 10. The incident prediction generator analyzes task-related impact data associated with the task at 1108. The task-related impact data is data associated with a task, such as the task-related impact data 116.

The incident prediction generator determines whether an incident is predicted based on the analysis results at 1110. If yes, the impact prediction component performs corrective measures at 1112. The process terminates thereafter.

While the operations illustrated in FIG. 11 are performed by a computing device, aspects of the disclosure contemplate performance of the operations by other entities. For example, a cloud service can perform one or more of the operations.

FIG. 12 is an exemplary flow chart illustrating operation of the computing device to assign a user to perform a task based on per-user safety scores. The process shown in FIG. 12 can be performed by an impact prediction component executing on a computing device, such as the computing device 102 in FIG. 1 and/or FIG. 3.

The process begins by analyzing sensor data to predict a potential incident associated with a task at 1202. The sensor data includes data generated by one or more sensor devices within a selected area, such as the plurality of sensor devices 132 in FIG. 1, the set of sensor devices 402 in FIG. 4, the sensor(s) 610 in FIG. 6 and/or the sensor(s) 616 in FIG. 6.

A task dependency component generates a dependency chain for the task at 1204. The dependency chain is a chain of dependent tasks, such as, but not limited to, the dependency chain 218 in FIG. 2 and FIG. 8. The task dependency component is a component such as, but not limited to, the task dependency component 216 in FIG. 2. The safety impact component calculates an impact score for a dependent task in the dependency chain at 1206. The impact score is a score indicating a degree of negative impact associated with the dependent task due to the predicted incident, such as, but not limited to, the impact score(s) 228 in FIG. 2 and/or the per-task impact score 1030 in FIG. 10.

The impact prediction component determines if the score is within a threshold range at 1208. If yes, the impact prediction component initiates corrective measures at 1210. The impact prediction component determines whether to continue at 1212. If yes, the process returns to operation 1202 and iteratively executes operations 1202 through 1212 until a determination not to continue is made at 1212. The process terminates thereafter.

While the operations illustrated in FIG. 12 are performed by a computing device, aspects of the disclosure contemplate performance of the operations by other entities. For example, a cloud service can perform one or more of the operations.

FIG. 13 is an exemplary flow chart illustrating operation of the computing device to perform a corrective action to prevent a predicted negative impact associated with dependent tasks. The process shown in FIG. 13 can be performed by an impact prediction component executing on a computing device, such as the computing device 102 in FIG. 1 and/or FIG. 3.

The process begins by analyzing real-time context data associated with a selected area with historical safety data using a set of safety criteria and pattern recognition at 1302. The incident prediction generator generates a predicted incident associated with a task being performed within the selected area at 1304. A task dependency component identifies a dependent chain associated with the task at 1306. A safety impact component analyzes the predicted incident and task data using a set of weighted task impact variables at 1308. The set of weighted task impact variables include variables such as, but not limited to, the set of weighted impact variables 504 in FIG. 5.

The safety impact component generates an impact score based on the analysis at 1310. The safety impact component determines if a negative impact occurs at 1312. The negative impact is associated with at least one dependent task is predicted to occur as a result of the predicted incident. If a negative impact occurs, the task assignment component re-assigns the task at 1314. The task can be re-assigned to a different user in some examples. The process terminates thereafter.

While the operations illustrated in FIG. 13 are performed by a computing device, aspects of the disclosure contemplate performance of the operations by other entities. For example, a cloud service can perform one or more of the operations.

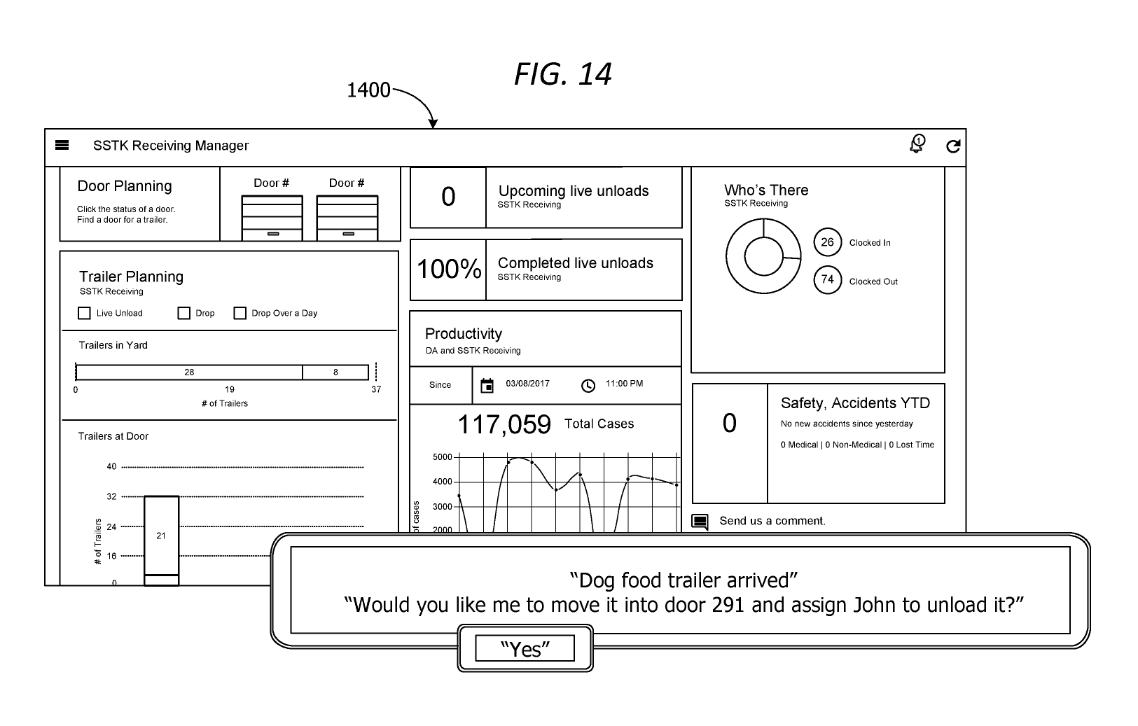

FIG. 14 is an exemplary screenshot 1400 illustrating task-related impact data. The screenshot 100 in this non-limiting example includes task-related impact data, such as door planning, trailer planning, trailers in the yard, trailers at the door, upcoming loads, completed live loads, productivity data, uses present (who's here), and safety/accidents. Task-related impact data can include other information associated with users, tasks, and selected areas.

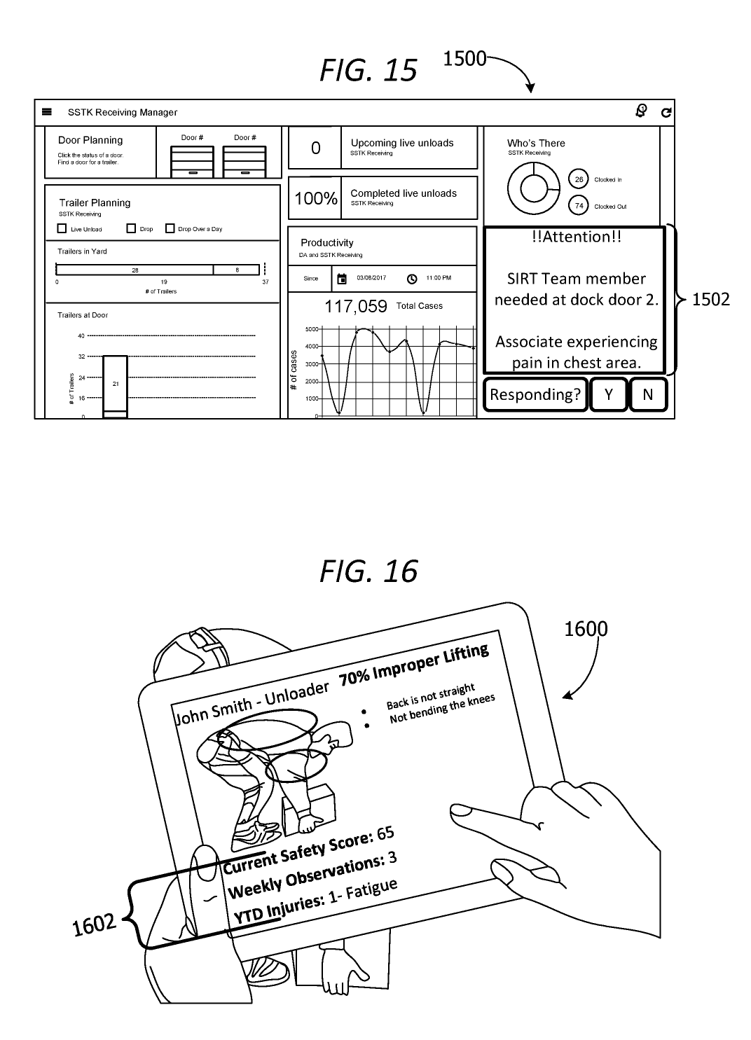

FIG. 15 is another exemplary screenshot 1500 illustrating task-related impact data and a notification 1502 associated with an incident. The screenshot 1500 in this non-limiting example is a screenshot of a manager dashboard for associated injury incident maintenance displayed on a user device. The screenshot 1500 can be generated by a task manager application 126 running on the user device, such as the task manager application 126 in FIG. 1.

In some examples, the task manager application notifies a user, such as a manger and/or a severe incident response team (SIRT) associate when assistance is needed. The task manager application allows the user to document the injury site with photographs and video from the user device. The task manager application can allow the user to record witness statements. The task manager application in some examples optionally includes safety videos for the training of other users, such as, but not limited to, training associated with how to safely lift an item/object. The task manager application optionally permits a user to photograph another user lifting a box or other item. The task manager application uses video analytics to analyze the photograph/image data and offers suggestions or other generated recommendations for safer lifting strategies to be employed by the user when performing lifting tasks.

The notification in this example is a notification requesting assignment of an additional user to assist at dock door two. The notification 1502 can include an alert regarding unsafe behavior and/or a condition requiring assistance. In other examples, the task manager application provides an injury history and the safety score for the user. The most common injuries and a pareto of their causes can be demonstrated by the task manager application so the user is enabled to take corrective action. The task manager application can also illustrate correct form/technique or otherwise provide coaching or additional instruction to assist the user in avoiding an injury or type of injury. The task manager application shows injury/accident trends since coaching was introduced or otherwise provided to the user.

The task manager application in other examples employs facial recognition to identify a user, including obtaining the name and information of a given user. Speech synthesis can be utilized to output notifications and/or recommended corrective actions to one or more users.

FIG. 16 is another screenshot 1600 illustrating task-related impact data and a safety score 1602 for a user. In this example, a user is assigned a per-task safety score of sixty-five associated with a lifting-related task. The task-related impact data includes injury incident maintenance data associated a user, such as year-to-date (YTD) injuries associated with the user, type of injuries, weekly observations, and details associated with the user's lifting technique.

### Additional Examples

In one example, the system monitors daily activity to capture image data and other sensor data related to user behavior while performing assigned tasks within a selected area, such as an unloading dock, a warehouse, a distribution center, or other area. The system identifies unsafe or potentially unsafe behaviors via analysis of daily monitoring data. The system generates alerts about identified behaviors from daily monitoring data. The system can suggest corrective actions to pro-actively mitigate injuries, avoid accidents, and/or prevent task completion delays improving safety and efficiency during performance of tasks.

In other examples, the task manager application identifies non-recommended actions and/or potentially unsafe conditions via analysis of daily monitoring data. The application generates recommended corrective actions to proactively prevent the predicted incidents before they occur.

The machine learning in some examples employs a neural network artificial intelligence that analyzes task-related impact data and context data to learn factors contributing to task completion delays, injuries, spills, congested areas, and/or other undesirable events. This enables the system to more accurately and effectively identify potential incidents and the impact of these predicted incidents on other tasks which have not yet been performed/completed.

In some examples, the system evaluates daily activity to take a pro-active step to predict potential for injury and correct actions prior to the predicted potential injury occurring. The system optionally provides a warning system to notify users of actions/activities likely to cause injury or lead to injury if not corrected.

In other examples, a user records task performance using a user device as the user performs tasks and/or moves through or within a given area. The system analyzes the image data generated by the user device to identify potential incidents and provide notifications on the user device if the captured image data indicates as unsafe behavior. Facial recognition on image data can be utilized to identify a user performing a task. If the user has a low safety score, the system prioritizes performance of corrective action associated with the user to prevent accident/injury based on the user's safety history.

In some examples, cameras are located throughout a monitored area, such as dock doors, loading/unloading zones, etc. The cameras generate image data used to monitor behavior of associates in real-time. The system performs image analysis of captured image data to identify potentially unsafe behavior/unrecommended behavior and address those potentially unsafe/unrecommended behaviors with corrective action. Corrective action can include sending a manager to speak with the associate or addressing the potentially unsafe behaviors in a training session based on a threshold level of unsafe behavior identified in the image data captured.

Users can carry a user device containing the task manager application as the users perform assigned tasks. The application notifies the users of task assignment changes, break schedule changes and modifications, time of the next break, length of the next break, corrective instructions, predicted incidents, task status, as well as provide possible injury/hazardous situation alerts via a user interface or other output device associated with the user device. Similarly, the user device can provide the location of the user and/or the user device associated with the user within a plurality of areas for congestion control and/or prevention of predicted incidents. The system can use the location of nearby users and/or user devices associated with users to determine impact of incidents on other tasks.

The system in other examples prioritizes sending one user to break now while delaying the break of another user to avoid congestion in each area and/or reduce idle time of users. When a user goes on break, the user can use an identification (ID) card or another identifying device to swipe out. When the user swipes out, the system logs the day and time the break begins and the time the break ends for compliance audit purposes.

In some examples, if a user is in an uncongested area but there are one or more dependent tasks waiting on the assigned task to be completed, the user's break will be delayed until the assigned task is completed if the delay is allowed by the break scheduling rules. If the task scheduling rules require the user to take a break immediately, the break will be schedule despite the dependencies, the lack of congestion, or incomplete task status because the break scheduling rules take precedence over mitigating congestions, completing tasks, or chain dependency.

In some examples, if the user's assigned task is incomplete, the user's next un-used break is due, and there is a second user assigned to a dependent task that is waiting for the first task to complete, the task assignment component schedules the first user and the second user to the same break time to minimize the second user's wait/idle time.

The system can utilize an algorithm to calculate when a user should go on their individual break based on a plurality of different variables, such as labor regulations, urgency of task completion, minimizing congestions, etc. For example, the variables can include a rule to prevent scheduling breaks which reduce congestion in one aisle/area only to increase congestion in another aisle/area. The system determines whether work/lack of work will impact other areas of the distribution center or other location.

Other variables the system can consider includes a variable for determining whether one person is waiting on another person's work to be completed. For example, if a task is loading a pallet, and this is the last pallet that needs to go onto a trailer before the trailer can depart (dock-out), it is worth delaying the user's break and sending the user into a congestion area to finish that task. In other examples, it can be more beneficial to send the user on break during a time of high congestion and wait until there is less congestion so that the user can work faster. In other words, the system predicts whether the congestion is likely to subside in certain areas during the user's break, whether the congestion can move to other areas, and/or whether the congestion is predicted to remain constant in the same area.

In other examples, the per-user break allocation system can prioritize order-filling and replenishment task assignments based on congestion “hot spots”. A congestion hot spot is an area that is now congested or an area that is predicted to become more congested within a given time-period. For example, if an order-filling trip is available that would send the order-filler into a high congestion area, the order-filling task assignment should be postponed unless (1) it is required to satisfy higher priority variables; (2) the order-filler can be sent to break prior to encountering the congestion; or (3) the congestion is unavoidable by trip/break manipulation.

The system in other examples can determine that order-fillers (users assigned to order-filling tasks) always go down a set path in a distribution center to fulfill certain orders, in a set order of steps. If the path is obstructed or congested, the system can use this data to predict a delay or other incident which can negatively impact other dependent tasks in the dependency chain.

In another example, order-fillers can typically walk down a middle aisle which is a shortest route to produce items. The system determines which break schedules enables the highest number of cases per hour to be filled, loaded and/or addressed by taking congestion on the set path into account when scheduling breaks for users assigned to order-filling tasks who are likely to user the path when not on break. In this example, the number of cases per hour is a performance indicator or performance metric for determining how quickly a case is moved and handled through the steps of a supply chain in man hours.

Some roles have less impact than other roles. For example, receiving workers (unload trailer/receive shipment) do not negatively impact other tasks in the chain as much as loaders. Once a truck is unloaded, the unloaders generally stop. In other areas, shipping for example, there are more users and more equipment involved with completing the assigned tasks. For example, shipping involves forklift drivers, order fillers who pick cases to build mixed-freight pallets to send to specific stores, haulers to take the mixed-freight pallets to loading dock, loaders who load onto truck, managers who validate, and seal pallets for shipment.

The machine learning component can test weighting of the different variables to analyze impact of a predicted delay or other predicted incident on the workflow for the specific area or location using predictive modeling. The machine learning component stores and refines the model based on real-time feedback and dynamic adjustments to customize the predictive model for a specific distribution center, a store, or other location, based on specific tasks, personnel, roles, and workflows at that specific location. The machine learning component can also problem solve by comparing different models for different distribution centers to determine why one distribution center weights certain variables differently than another distribution center for further refining the model at a higher (regional, state, national, or global) level.

The system can analyze the task-related impact data via the machine learning model using the weighted impact variables. The system dynamically outputs predicted incidents, negative impacts, and/or corrective measures based on the analysis results. The predictions and task schedules are updated in real-time as events occur during the day based on the weighted impact variables. The variables are weighted in some examples based on the calculation of impact of one person's role/task on another person's role/task, in addition to the congestion, demand, and relevant laws/labor regulations to mitigate latency in the supply chain. In other words, the task schedules minimize time wasted and optimize breaks based on real-time, impact-related feedback. The feedback can include shipment changes, unexpected occurrences on the floor (pallet gets knocked over or spilled), accidents, delays, broken/damaged items, user injuries, users out sick, etc.

In some examples, the system employs neural network and artificial intelligence to dynamically allocate tasks and work breaks to an associated. The system determines congestion areas, congestion times, and identifies potential delays in task performance. The system adjusts the scheduled tasks and/or break time of one or more users to minimize negative impact, such as congestion or delay, using a set of rules to determine how many breaks per user shift, a priority of work assigned to each user, and/or priority/urgency to schedule a user's break.

Alternatively, or in addition to the other examples described herein, examples include any combination of the following:
a notification component, implemented on the at least one processor, that generates a predicted incident notification and outputs the predicted incident notification to a client device associated with the manager prior to occurrence of the predicted incident;
a minimum safety threshold, wherein a task assignment component re-assigns the selected task to the second user on determining the generated safety impact score is outside the minimum safety threshold;
a safety impact score threshold range, wherein the safety impact component outputs corrective instructions to the first user on determining a safety impact score assigned to the first user is within the safety impact score threshold range to assist the first user with completion to the selected task;
identifying a second task in the set of child tasks to be assigned to a user in the plurality of users;
identifying a per-task safety score assigned to each user in the plurality of users;
assigning the second task to the user in the plurality of users having a highest per-task safety score associated with the second task;
a machine learning component, implemented on the at least one processor, that obtains safety feedback from a plurality of sources and analyzes the safety feedback with predetermined safety goals and historical safety data to generate an updated set of variable weights;
wherein the updated variable weights are utilized by the safety impact component to calculate a per-task safety score for the first user based on performance of the selected task;
a set of impact variables comprising a set of task scheduling rules, task priorities, task dependencies, incident avoidance rules, task completion goals, and safety goals;
wherein the set of impact variables are combined with a set of variable weights to generate the set of weighted task impact variables;
a safety impact component, implemented on the at least one processor, that calculates a per-task safety score for each user in the plurality of users assigned to perform at least one task in a plurality of tasks to be performed during a given time-period within the selected area based on the real-time context data, sensor data generated by a plurality of sensors within the selected area, per-user historical safety data, and a set of behavior criteria;
a second task in the plurality of tasks to be performed by a third user concurrently with performance of the first task by the first user, wherein the second task and the first task are sibling tasks;
generating an incident prediction associated with both the first task and the second task based on the real-time context data, sensor data generated by at least one sensor associated with a selected area, and historical safety data associated with the first user and the second user;
wherein a predicted incident associated with the first task results in a dependent-task negative impact associated with performance of the second task;
on condition the task impact score indicates an acceptable safety impact on the selected task, confirming assignment of tasks in the set of dependent tasks;
wherein initiating the corrective measures further comprises reassigning the at least one dependent task to at least one user having a highest per-task safety impact score;
wherein initiating the corrective measures further comprises outputting corrective instructions to a user device associated with at least one user assigned to perform the at least one dependent task on condition the impact score indicates a negative impact on the selected task;
identifying a set of users assigned to perform the set of dependent tasks associated with the selected task;
generating a safety impact score indicating a safety impact of a predicted incident associated with a first task in the set of dependent tasks on at least one other dependent task in the set of dependent tasks, wherein a dependent task comprises a parent task, a child task, or a sibling task;
identifying the set of parent tasks associated with the selected task based on the dependency chain;
generating a per-task safety impact score for each parent task, wherein the per-task safety impact score for a selected parent task indicates an impact of a predicted incident associated with the selected parent task on completion of the selected child task;
obtaining safety feedback from a plurality of sources;
analyzing the safety feedback with a set of predetermined safety goals to generate an updated set of variable weights;
wherein the updated variable weights are utilized by the safety impact component to generate task allocations and calculate safety impact scores;
calculating the set of weighted task impact variables by combining a set of variable weights with a set of impact variables, the set of impact variables comprising a set of task scheduling rules, task priorities, task dependencies, incident avoidance rules, safety goals, and task completion goals;
wherein the set of impact variables are combined with a set of variable weights to generate the set of weighted task impact variables;
identifying a parent task in the set of dependent tasks to be assigned to a user in a plurality of users, wherein the selected task is dependent upon completion of the parent task prior to completion of the selected task;
identifying a per-task safety score assigned to each user in the plurality of users;
assigning the second task to the user in the plurality of users having a highest per-task safety score associated with the second task;
generating an updated set of variable weights based on analysis of safety feedback obtained from a plurality of sources using predetermined safety goals and a set of pattern recognition data, wherein the updated variable weights are utilized to calculate a per-task safety score for the first user based on performance of the selected task.
wherein the selected user is a first user assigned to a first task and wherein the dependency chain identifies a parent task assigned to a second user, wherein initiation of the first task requires completion of the parent task;
wherein the selected user is a first user assigned to a first task and wherein the dependency chain identifies a child task assigned to a second user, wherein initiation of the child task requires completion of the first task;
wherein the selected user is a first user assigned to a first task, wherein the dependency chain identifies a second task assigned to a second user, wherein the first task and the second task are configured to be performed concurrently;
a machine learning component, implemented on the at least one processor, that obtains performance feedback from a plurality of sources and analyzes the performance feedback with predetermined performance goals to generate an updated set of variable weights, wherein the updated variable weights are utilized by the safety impact component to calculate predicted incident impact scores associated with a given task;
outputting the incident prediction notification to a client device associated with the selected user;
selecting a second user having a highest per-task safety score and assigning the selected task to the second user;
identifying a set of users assigned to perform the set of dependent tasks associated with the same task dependency chain;
obtaining performance feedback from a plurality of sources;
analyzing the performance feedback with predetermined performance goals to generate an updated set of variable weights, wherein the updated variable weights are utilized to calculate task impact scores;
calculating the set of weighted impact variables by combining a set of variable weights with a set of impact variables, the set of impact variables comprising a set of task scheduling rules, task priorities, task dependencies, congestion avoidance rules, and task completion goals, wherein the set of impact variables are combined with a set of variable weights to generate the set of weighted impact variables;
calculating a predicted incident impact score for a proposed task assignment based on the dependency chain, the task-related impact data, and a set of weighted impact variables;
on determining the calculated impact score falls below an impact threshold, assigning the task to the selected user;
on determining the calculated impact score exceeds the impact threshold, performing corrective measures to reduce likelihood of the predicted incident and/or prevent the predicted incident;
generating a safety score for each user in the plurality of users based on feedback associated with at least one task assigned to each user in the plurality of users; and
generating a predicted incident notification for the selected user and outputting the notification to a user device associated with a set of users, the set of users comprising the selected user and a supervisor associated with the selected user.

At least a portion of the functionality of the various elements in FIG. 1, FIG. 2, FIG. 3, FIG. 4, FIG. 5, FIG. 6, FIG. 7, FIG. 8, FIG. 9, and FIG. 10 can be performed by other elements in FIG. 1, FIG. 2, FIG. 3, FIG. 4, FIG. 5, FIG. 6, FIG. 7, FIG. 8, FIG. 9, and FIG. 10, or an entity (e.g., processor, web service, server, application program, computing device, etc.) not shown in FIG. 1, FIG. 2, FIG. 3, FIG. 4, FIG. 5, FIG. 6, FIG. 7, FIG. 8, FIG. 9, and FIG. 10.

In some examples, the operations illustrated in FIG. 11, FIG. 12, and FIG. 13 can be implemented as software instructions encoded on a computer readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

In another example, the elements illustrated in FIG. 1, FIG. 2, FIG. 3, FIG. 4, FIG. 5, FIG. 6, FIG. 7, FIG. 8, FIG. 9, and FIG. 10, such as when encoded to perform the operations illustrated in FIG. 11, FIG. 12, and FIG. 13, constitute exemplary means for analyzing real-time context data associated with a selected area and historical safety data using a set of safety criteria and pattern recognition variables to predict occurrence of at least one incident associated with at least one task being performed within the selected area; exemplary means for generating a dependency chain associated with a selected task associated with the predicted incident, the selected task assigned to a first user in a plurality of users within the selected area, the dependency chain identifying a set of child tasks dependent upon completion of the selected task assigned to the first user; and exemplary means for calculating an impact score for the set of child tasks based on an analysis of the generated incident prediction, task data associated with the set of child tasks and a set of weighted task impact variables; and exemplary means for re-assigning the selected task to a second user having a higher per-task safety score than the first user on condition the safety impact score indicates a dependent-task negative impact associated with at least one child task in the set of child tasks as a result of the predicted incident.

In another example, the elements illustrated in FIG. 1, FIG. 2, FIG. 3, FIG. 4, FIG. 5, FIG. 6, FIG. 7, FIG. 8, FIG. 9, and FIG. 10, such as when encoded to perform the operations illustrated in FIG. 11, FIG. 12, and FIG. 13, constitute exemplary means for calculating a per-task safety score for each user in a plurality of users qualified to perform a selected task in a plurality of tasks within a task dependency chain, the per-task safety score calculated based on analysis of historical safety data for the plurality of users and task data associated with the selected task; exemplary means for assigning the selected task to a first user in the plurality of users having a highest per-task safety score associated with the selected task; exemplary means for analyzing context data associated with the selected area, sensor data generated by a set of sensors associated with the selected area, task data associated with a set of dependent tasks in a dependency chain associated with the selected task, and a set of incident predictions associated with the set of dependent tasks using a set of weighted task impact variables to generate an impact score for the set of dependent tasks; and exemplary means for initiating corrective measures associated with the at least one dependent task on condition the task impact score indicates a negative impact on the selected task due to at least one incident predication associated with at least one dependent task in the set of dependent tasks within the dependency chain.

In another example, the elements illustrated in FIG. 1, FIG. 2, FIG. 3, FIG. 4, FIG. 5, FIG. 6, FIG. 7, FIG. 8, FIG. 9, and FIG. 10, such as when encoded to perform the operations illustrated in FIG. 11, FIG. 12, and FIG. 13, constitute exemplary means for generating a dependency chain associated with a selected task assigned to a first user in a plurality of users within a selected area on condition a generated incident prediction indicates occurrence of a predicted incident associated with the selected task prior to task completion, the dependency chain identifying a set of dependent tasks, a dependent task comprising a sibling task completed substantially concurrently with the selected task or a child task dependent upon completion of the selected; exemplary means for calculating an impact score for the set of dependent tasks based on an analysis of the generated incident prediction, task data associated with the set of dependent tasks and a set of weighted impact variables; and exemplary means for re-assigning the first task to a second user on condition the impact score is within a safety impact score threshold range indicating a negative safety impact on at least one user assigned to at least one dependent task in the set of dependent tasks.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more or less functionality than illustrated and described herein.

In examples involving a general-purpose computer, aspects of the disclosure transform the general-purpose computer into a special-purpose computing device when configured to execute the instructions described herein.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for relational-impact based task allocation, the system comprising:
a memory;
at least one processor communicatively coupled to the memory;
a plurality of sensor devices within a selected area generating sensor data associate with the selected area;
an incident prediction generator, implemented on the at least one processor, that analyzes real-time context data associated with the selected area, the sensor data and historical safety data using a set of safety criteria and pattern recognition variables to predict an incident associated with at least one task being performed within the selected area;
a task dependency component, implemented on the at least one processor, that generates a dependency chain associated with a selected task associated with the predicted incident, the selected task assigned to a first user in a plurality of users within the selected area, the dependency chain identifying a set of child tasks dependent upon completion of the selected task assigned to the first user; and
a safety impact component, implemented on the at least one processor, that calculates an impact score for the set of child tasks based on an analysis of the predicted incident, task data associated with the set of child tasks and a set of weighted task impact variables, the selected task is re-assigned to a second user having a higher per-task safety score than the first user on condition a safety impact score indicates a dependent-task negative impact associated with at least one child task in the set of child tasks as a result of the predicted incident.

2. The system of claim 1, further comprising:
a notification component, implemented on the at least one processor, that generates a predicted incident notification and outputs the predicted incident notification to a client device associated with a manager prior to occurrence of the predicted incident.

3. The system of claim 1, further comprising:
a minimum safety threshold, wherein a task assignment component re-assigns the selected task to the second user on determining the safety impact score is outside the minimum safety threshold.

4. The system of claim 1, further comprising:
a safety impact score threshold range, wherein the safety impact component outputs corrective instructions to the first user on determining the safety impact score associated with the first user is within the safety impact score threshold range to assist the first user with completion of the selected task.

5. The system of claim 1, further comprising:
identifying a second task in the set of child tasks, the second task is an unassigned task;
identifying a per-task safety score assigned to each user in the plurality of users; and
assigning the second task to a third user in the plurality of users, wherein the third user has a highest per-task safety score associated with the second task.

6. The system of claim 1, further comprising:
a machine learning component, implemented on the at least one processor, that obtains safety feedback from a plurality of sources and analyzes the safety feedback with predetermined safety goals and the historical safety data to generate an updated set of variable weights, wherein the updated set of variable weights are utilized by the safety impact component to calculate a per-task safety score for the first user based on performance of the selected task.

7. The system of claim 1, further comprising:
a set of impact variables comprising a set of task scheduling rules, task priorities, task dependencies, incident avoidance rules, task completion goals, and safety goals, wherein the set of impact variables are combined with a set of variable weights to generate the set of weighted task impact variables.

8. The system of claim 1, further comprising:
the safety impact component, implemented on the at least one processor, that calculates a per-task safety score for each user in the plurality of users assigned to perform the at least one task in a plurality of tasks to be performed during a given time-period within the selected area based on the real-time context data, the sensor data generated by the plurality of sensors within the selected area, per-user historical safety data, and a set of behavior criteria.

9. The system of claim 1 further comprising:
a second task in the plurality of tasks to be performed by a third user concurrently with performance of a first task by the first user, wherein the second task and the first task are sibling tasks; and
generating an incident prediction associated with both the first task and the second task based on the real-time context data, sensor data generated by at least one sensor associated with the selected area, and the historical safety data associated with the first user and the second user, wherein the incident prediction associated with the first task results in the dependent-task negative impact associated with the performance of the second task.

10. A computer-implemented method for relational-impact based task allocation, the computer-implemented method comprising:
analyzing, by a safety impact component, historical safety data for the plurality of users and task data associated with the selected task;
calculating, by the safety impact component, a per-task safety score for each user in a plurality of users qualified to perform a selected task in a plurality of tasks within a dependency chain based on the analysis of the historical safety data and the task data;
assigning, by a task assignment component, the selected task to a first user in the plurality of users having a highest per-task safety score associated with the selected task;
analyzing, by the safety impact component, task-based impact data and a set of incident predictions associated with a set of dependent tasks in the dependency chain associated with the selected task using a set of weighted task impact variables, the task-based impact data comprising context data associated with a selected area, sensor data generated by a set of sensors associated with the selected area, and the task data associated with the set of dependent tasks;
generating an impact score for the set of dependent tasks based on the analysis of the set of incident predictions and the task-based impact data; and
on condition a task impact score indicates a negative impact on the selected task due to at least one incident predication associated with at least one dependent task in the set of dependent tasks within the dependency chain, initiating, by a notification component, corrective measures associated with the at least one dependent task.

11. The computer-implemented method of claim 10, further comprising:
on condition the task impact score indicates an acceptable safety impact on the selected task, confirming assignment of tasks in the set of dependent tasks.

12. The computer-implemented method of claim 10, wherein initiating the corrective measures further comprises:
reassigning the at least one dependent task to a second user in the plurality of users having a highest per-task safety score associated with the at least one dependent task.

13. The computer-implemented method of claim 10, wherein initiating the corrective measures further comprises:
outputting corrective instructions to a user device associated with at least one user assigned to perform the at least one dependent task on condition the impact score indicates the negative impact on the selected task.

14. The computer-implemented method of claim 10, further comprising:
identifying a set of users assigned to perform the set of dependent tasks associated with the selected task; and
generating a safety impact score indicating a safety impact of a predicted incident associated with a first task in the set of dependent tasks on at least one other dependent task in the set of dependent tasks, wherein a dependent task comprises a parent task, a child task, or a sibling task.

15. The computer-implemented method of claim 10, wherein the selected task is a child task dependent upon a set of parent tasks and further comprising:
identifying the set of parent tasks associated with the selected task based on the dependency chain; and
generating a per-task safety impact score for each parent task, wherein the per-task safety impact score for a selected parent task indicates an impact of a predicted incident associated with the selected parent task on completion of the child task dependent upon the set of parent tasks.

16. The computer-implemented method of claim 10, further comprising:
obtaining safety feedback from a plurality of sources; and
analyzing the safety feedback with a set of predetermined safety goals to generate an updated set of variable weights, wherein the updated variable weights are utilized by the safety impact component to generate task allocations and calculate safety impact scores.

17. One or more computer storage media, having computer-executable instructions for impact based task assignment that, when executed by a computer cause the computer to perform operations comprising:
generating a dependency chain associated with a first task assigned to a first user in a plurality of users within a selected area on condition a generated incident prediction indicates a predicted occurrence of an incident associated with the first task prior to completion of the first task, the dependency chain identifying a set of dependent tasks associated with the first task, a dependent task comprising a sibling task completed substantially concurrently with the first task or a child task dependent upon the completion of the first task;
calculating an impact score for the set of dependent tasks based on an analysis of the generated incident prediction, task data associated with the set of dependent tasks and a set of weighted impact variables; and
re-assigning the first task to a second user in the plurality of users on condition the impact score is within a safety impact score threshold range indicating a negative safety impact on at least one user assigned to at least one dependent task in the set of dependent tasks.

18. The one or more computer storage media of claim 17, wherein the computer-executable instructions for impact-based task assignment further comprises:
calculating the set of weighted task impact variables by combining a set of variable weights with a set of impact variables, the set of impact variables comprising a set of task scheduling rules, task priorities, task dependencies, incident avoidance rules, safety goals, and task completion goals, wherein the set of impact variables are combined with the set of variable weights to generate the set of weighted task impact variables.

19. The one or more computer storage media of claim 17, wherein the computer-executable instructions for impact based task assignment further comprises:
identifying a second task in the set of dependent tasks, wherein the second task is a parent task and wherein the first task is dependent upon completion of the second task;
identifying a per-task safety score assigned to each user in the plurality of users; and
assigning the second task to a third user in the plurality of users having a highest per-task safety score associated with the second task.

20. The one or more computer storage media of claim 17, wherein the computer-executable instructions for impact based task assignment further comprises:
generating an updated set of variable weights based on analysis of safety feedback obtained from a plurality of sources using predetermined safety goals and a set of pattern recognition data, wherein the updated variable weights are utilized to calculate a per-task safety score for the first user based on performance of the first task.
